(19) United States
(12) Patent Application Publication
(10) Pub. No.: US 2013/0314273 A1
(43) Pub. Date: Nov. 28, 2013

(54) Wireless and Wireline Sensor Nodes, Micro-Radar, Networks and Systems

(71) Applicants: Robert A. Kavaler, Kensington, CA (US); Akhila Raman, Berkeley, CA (US); Ravneet Bajwa, Berkeley, CA (US); Ram Rajagopal, Palo Alto, CA (US); Pravin Varaiya, Berkeley, CA (US)

(72) Inventors: Robert A. Kavaler, Kensington, CA (US); Akhila Raman, Berkeley, CA (US); Ravneet Bajwa, Berkeley, CA (US); Ram Rajagopal, Palo Alto, CA (US); Pravin Varaiya, Berkeley, CA (US)

(73) Assignee: SENSYS NETWORKS, INC., Berkeley, CA (US)

(21) Appl. No.: 13/824,320

(22) PCT Filed: Dec. 30, 2011
(86) PCT No.: PCT/US11/68232

§ 371 Date: Aug. 9, 2013

Related U.S. Application Data
(60) Provisional application No. 61/428,820, filed on Dec. 30, 2010.
(60) Provisional application No. 61/478,226, filed on Apr. 22, 2011.
(60) Provisional application No. 61/581,620, filed on Dec. 29, 2011.
(60) Provisional application No. 61/582,157, filed on Dec. 30, 2011.

(51) Int. Cl. G01S 13/88

(52) U.S. Cl. CPC G01S 13/886
USPC 342/90

(57) ABSTRACT

The following are disclosed and claimed: A micro-radar adapted to generate an antenna output of less than or equal to 10 milli-Watt (mW) through an antenna to an object and receive a Radio Frequency (RF) reflection off of said object, and adapted to respond to a first Digital to Analog Converter (DAC) output and a second DAC output. A wireless sensor node and/or a processor for use in said wireless sensor node. A wireline sensor node and/or a processor for use in said wireline sensor node configured operate said micro-radar by control of said first and said second DAC output. A second apparatus configured to receive an improved sensor report from at least two of the wireless sensor nodes. A processor for use with the second apparatus. A third apparatus adapted to respond to vibrations in pavement. Several integrated circuits and systems. Installation devices, servers and/or computer readable memories. Finite State Machines, computers, memories containing and/or using program systems and/or installation packages.

### CROSS REFERENCE TO RELATED PATENT APPLICATIONS

This application claims priority to
International Application No. PCT/US2011/068232, filed Dec. 30, 2011, entitled “Wireless and Wireline Sensor Nodes, Micro-Radar, Networks and Systems”, and
U.S. patent application Ser. No. 12/982,836, filed Dec. 30, 2010, entitled “Emulating Increased Sample Frequency in a Wireless Sensor Node and/or a Wireless Sensor Network”;

International Application no. PCT/US2011/068232 claims priority to the following:
Provisional Patent Application no. 61582157, filed Dec. 30, 2011, entitled “Wireless and Wireline Sensor Nodes, Micro-Radar, Networks and Systems”,
Provisional Patent application No. 61/581,620 filed Dec. 29, 2011, entitled “Micro-Radar, Micro-Radar Sensor Nodes, Networks and Systems”,
Provisional Patent Application No. 61/478,226 filed Apr. 22, 2011, entitled “In-Pavement Wireless Vibration Sensor Nodes, Networks and Systems”, and to
Provisional Patent Application No. 61/428,820 filed Dec. 30, 2010 entitled “In-pavement Accelerometer-Based Wireless Sensor Nodes, Networks and Systems and/or Emulating Increased Sample Frequency in a Wireless Sensor Node and/or a Wireless Sensor Network”;

U.S. patent application Ser. No. 12/982,836 claims priority to
U.S. Provisional Patent Application Ser. No. 61/291,595, filed Dec. 31, 2009, and
U.S. Provisional Patent Application Ser. No. 61/428,820, filed Dec. 30, 2010;

All of which are incorporated herein in their entirety.

### TECHNICAL FIELD

This disclosure relates to several things: First, this disclosure relates to signal estimation for wireless sensor nodes that operate sensors with batteries. The invention emulates increasing the sampling frequency with little or no additional drain on the batteries. The invention also relates to using these improved sensor readings to generate vehicle parameters such as length, number of axles, and axle positions, movement estimates such as velocity and acceleration, and traffic ticket messages based upon the movement estimates and/or the vehicle parameters. Any combination of these parameters, estimates and/or messages may be sent to other systems.

Second, this disclosure relates to systems that use a wireless sensor network including vibration sensor nodes embedded in pavement, referred to herein as second systems. The invention also relates to second systems that use vibration readings to generate vehicle parameters that may be used to generate a vehicle classification. The second system may also monitor the weight of vehicles and/or their deflection of the pavement while passing over, or near, the sensor node to assess the pavement damage, notify traffic enforcement of traffic violations, tariff fees and/or insurance companies of vehicles they have insured.

Third, this disclosure relates to micro-radars, radar antennas, sensor nodes adapted to interact with a micro-radar, and processors adapted to respond to the micro-radar, as well as components and systems supporting communications between the micro-radars and the processors. The processors and systems may further support traffic analysis and management of moving and/or stationary vehicles.

### BACKGROUND OF THE INVENTION

The Background of this disclosure is in three parts:

First, a wireless sensor node operates by using power only when operating its sensors, a processor, its wireless transmitter and/or its receiver. The more often it operates its sensors, the shorter its battery life expectancy. While some wireless sensor nodes may be equipped with solar cells or some other renewable energy source, such sources tend to only be available for part of the time, such as sunny days. Methods and apparatus are needed to emulate increasing the sampling frequency without additionally operating the sensor, thereby conserving battery power.

Second, vehicles are typically classified into different categories, such as passenger vehicles, buses and trucks of different sizes. Transportation agencies collect vehicle classifications to plan highway maintenance programs, evaluate highway usage, and optimize the deployment of various resources. There are many classification schemes, but the most common ones use axle counts and the spacing between axles.

Transportation agencies measure the weight of vehicles on roads and bridges in order to monitor the state of their repair, enforce weight limits, and charge vehicles fees based on weight criteria. Some agencies use vehicle weight data to predict damage that can be fixed by preservation, which is more cost-effective than rehabilitation. Today, this information is acquired at vehicle weigh stations. To adequately predict the state of repair requires many more weigh stations, which costs too much.

There are two basic kinds of weigh stations, static and Weigh In Motion (WIM). Static weigh stations employ bending plates, piezoelectric and load cell sensors to estimate the weight of stopped vehicles. They need substantial space along a road for measurement. The stations are expensive to install and staff. Every vehicle to be weighed must be stopped, wasting valuable time. This stoppage tends to create long queues of vehicles stretching past the station, which poses traffic safety hazards. The vehicles merging back into traffic after being weighed can cause accidents also.

WIM stations are replacing static weigh stations. Using the same sensors as static weigh stations, WIM stations estimate axle load while a vehicle is moving at highway speeds. They are also expensive and require frequent calibration as well as concrete pavement installed before and after the station.

Some unstaffed WIM stations use a camera to capture the license number or USDOT ID of any vehicle whose WIM measurements suggest it is overweight. These stations, which are referred to as virtual WIM stations, are also expensive and require frequent calibration.

Third, there has been extensive development of radar since the 1930's for detecting aircraft and ships at a distance, often over the horizon. Such systems routinely use many kilowatts to megawatts for transmitting their radar pulses. What is disclosed herein are micro-radars that use a milli-Watt (mW) or less of power to transmit their pulses. Micro-radars are also used to detect vehicles and determine distances, but the distances involved are typically within a few meters of the micro-radar.

### SUMMARY OF INVENTION

There are three distinct aspects of the disclosed and claimed inventions to be summarized and there are some unifying definitions that apply across all aspects.
The first aspect is focused on wireless sensor nodes and what can be done to improve their sampling frequency while reducing their power consumption.
The second aspect is focused on apparatus and method responding to vibrations in pavement from vehicles.
The third aspect is focused on micro-radars, with a discussion that can reduce manufacturing and installation costs, improve the consistency and accuracy of their use in a variety of settings and in particular, when interacting with sensor nodes, processors, networks and/or systems, possibly applied to vehicle traffic analysis and/or management and/or production management.

The unifying definitions include the following:
A wireless sensor node may have components and/or operational adaptations and/or configurations disclosed in any combination of the aspects.
A wireline sensor node may have components and/or operational adaptations and/or configurations disclosed in any combination of the aspects.
An access point may have components and/or operational adaptations and/or configurations disclosed in any combination of the aspects.
A server may have may have components and/or operational adaptations and/or configurations disclosed in any combination of the aspects.
A processor may have components and/or operational adaptations and/or configurations disclosed in any combination of the aspects. This is applicable whether or not the processor is included in a wireless sensor node, a wireline sensor node, an access point, and/or a server, as well as when the processor may communicate with any of these sensor nodes, access points, and/or servers.
A system may have components and/or operational adaptations and/or configurations disclosed in any combination of the aspects. This is applicable to any of the following a traffic speed enforcement system, a traffic monitoring system, a traffic management system, a parking management system, and/or a production management system.
A radar as used herein includes embodiments that may or may not be a micro-radar, as will be discussed in detail in the third aspect.
A vehicle may be embodied in any combination of discussions from the three aspects. For example, it may act as an object in the third aspect, reflecting the antenna output of a radar, in particular a micro-radar.
The components of the unified defined terms mentioned above may be disclosed as implemented by computers in more than one aspect. The implementation of the components may include just one or more computers instructed by program systems of those aspects. For example, a computer implementing a processor in a wireless sensor node may include configurations disclosed in each of the aspects, but implemented by a single computer instructed from a single accessible memory containing a merged program system incorporating elements of program systems from each of the aspects.

Regarding the First Aspect:

Two sets of embodiments are disclosed. The first set includes a first apparatus and possibly a second apparatus. The first apparatus is configured for use with a wireless sensor node and includes a processor. The processor may be configured to receive a sensor reading, N times per time unit, generated by a sensor, where N may be at least two. The processor generates an improved estimate, and/or an improved time stamp. The improved estimate and/or time stamp emulates the sensor readings received at an increased sampling frequency. The increased sampling frequency may be at least twice the N times per time unit.

The wireless sensor node may include the apparatus and a battery configured to provide electrical power to the apparatus. The battery may be configured to receive power from at least one photovoltaic cell. An integrated circuit and/or a circuit board may include the apparatus.

The improved estimate may include at least part of an improved sensor reading and/or at least one improved reading characteristic. The improved reading characteristic may include an edge estimate and/or an extrema estimate and/or a frequency domain estimate. The edge estimate may estimate a rising edge, a falling edge, a leading edge and/or a trailing edge. The extrema estimate may estimate a local minimum or a local maximum of at least part of the improved sensor readings. The frequency domain estimate may include at least one frequency band amplitude.

The second apparatus may be configured for use with the wireless sensor nodes implementing the first apparatus. The second apparatus may receive an improved sensor report from each of at least two of the wireless sensor nodes to create a table of the improved reading characteristics.

The second apparatus may include a second processor configured to generate a vehicle parameter, a movement estimate and/or a traffic ticket message about a vehicle passing near one or more of the wireless sensor nodes. The vehicle parameters may include the estimated length of the vehicle, an axle count and/or at least one axle position. The movement estimate of the vehicle may include a velocity estimate and/or an acceleration estimate. The movement estimate may further include a confidence estimate of the velocity and/or acceleration estimates.

The movement estimate may be based upon a first correlation of the extrema estimates from the wireless sensor nodes and/or upon a second correlation of the edge estimates. For example, the first correlation of the extrema estimates may match local minima and local maxima from the tables of improved reading characteristics to create correlated extrema. The movement estimate may be based upon a difference in the time stamps of the correlated extrema.

The second apparatus may further include a removable interface coupling coupled to the second processor. The second processor may be further configured to use the removable interface coupling to receive the improved sensor report and to send the vehicle parameter, the movement estimate, and/or the traffic ticket message, to the access point and possibly to other systems. The removable interface coupling may be compatible with any version of a USB protocol, a Firewire protocol, and/or a LAN protocol.

A second circuit board and/or a second integrated circuit may include the second processor. An access point configured to wirelessly communicate with the wireless sensor nodes may include the second processor.

A second set of embodiments includes a third apparatus with a third processor. The third processor may be configured to respond to sensor reports received from wireless sensor nodes based upon sensor readings. The sensor readings are generated by sensors N times per time unit in each of the wireless sensor nodes. The third processor may respond to receiving the sensor reports by generating an improved estimate and/or an improved time stamp. The improved estimate and/or time stamp emulates sensor readings generated at an increased sampling frequency. The increased sampling frequency may be at least twice the N times per time unit.

The third processor may be further configured to generate at least part of the vehicle parameter, the movement estimate of the vehicle, and the traffic ticket message as previously discussed. The third processor may be configured to communicate with an access point similar to the second processor. A third integrated circuit, a third circuit board, and/or the access point, may include the third processor.

Regarding the Second Aspect:

Apparatus and methods are disclosed that may be configured to respond to vibrations in a pavement induced by the travel of a vehicle on the pavement. This summary will start by describing an embedded wireless vibration sensor and how the embedded wireless vibration sensor may be used in a second system. The potential component(s) that may be used to make the embedded wireless vibration sensor will be discussed. The embedded wireless vibration sensor can be installed in minutes in any type of pavement (asphalt or concrete). Some of the operational variations will then be mentioned.

The embedded wireless vibration sensor node is embedded in pavement and may include at least one vibration sensor and at least a radio transmitter and often a radio transceiver. The embedded wireless vibration sensor node may be configured to operate as follows: The vibration sensor may respond to the vibrations by generating at least one vibration reading. A vibration report may be generated based upon at least one, and often many, of the vibration readings. The radio transmitter may be configured to send the vibration report. The vibrations of the pavement may be generated based upon the movement of the vehicle and its deflection of the pavement near the embedded wireless vibration sensor node.

The second system may use the vibration report to generate at least one vehicle parameter. The vehicle parameter may include a length estimate, an axle count estimate, an axle position estimate vector, an axle spacing vector and/or an axle width estimate. In certain implementations, the vehicle parameter may include each of these components. The vehicle parameters may be used to generate a vehicle classification for the vehicle.

The second system may use the vibration report to generate a weight estimate of the vehicle and/or a deflection estimate of the vehicle acting on the pavement. In some implementations, a movement estimate and/or the vehicle parameters may be used to further support generating the weight estimate and/or the deflection estimate.

A vehicle identification may be used with the vehicle classification and the weight estimate and/or the deflection estimate, as well as possibly the vehicle parameters and the movement estimate, to generate a vehicle travel record. The vehicle travel record may also include the vehicle classification, as well as possibly a time stamp.

The vehicle travel record may be used to generate a traffic ticket message, and/or a tariff message, and/or an insurance message, for the vehicle. These messages may include much the same information, but may differ in terms of when they are generated and whom they are sent to. The traffic ticket message may only be generated when the vehicle is breaking a traffic regulation. The tariff message may be sent for all vehicles in certain vehicle classifications and/or exceeding a certain weight threshold and/or a deflection threshold. The insurance message may only be generated for vehicles whose vehicle identifications indicate that an insurance company has agreed to pay for the insurance message about the vehicle.

The embedded wireless vibration sensor node may be built from any of several components, in particular, a vibration sensor module, a wireless vibration sensor, and/or a wireless vibration sensor node.
The vibration sensor module may include at least one vibration sensor configured to respond to the vibrations in the pavement to create at least one vibration reading.
The wireless vibration sensor may include the vibration sensor and a radio transmitter configured to send the vibration report based upon the vibration reading.
The wireless vibration sensor node may be configured for embedding in the pavement and may include the vibration sensor and the radio transmitter and/or transceiver.

The apparatus may further include at least one of the following processors:
A fourth processor configured to respond to the vibration readings to generate the vibration report.
A fifth processor configured to respond to the vibration report to generate at least one vehicle parameter.
A sixth processor configured to respond to the vehicle parameter of the vehicle to generate the vehicle classification.
A seventh processor configured to respond to the vibration report to generate the weight estimate and/or the deflection estimate.
A eighth processor configured to respond to the vehicle classification, a vehicle identification, a vehicle movement estimate, the weight estimate and/or the deflection estimate to generate a vehicle travel record.
And a ninth processor configured to respond to the vehicle travel record to generate the traffic ticket message, the tariff message and/or the insurance message.

An access point may be configured to wirelessly communicate with at least one of the embedded wireless vibration sensor nodes to receive the vibration reports. Various combinations of the second through the ninth processor may be implemented in the access point. In some implementations, the embedded wireless vibration sensor node may implement some of the processors.

These processors individually and/or collectively may be implemented as one or more instances of a processor-unit that may include a finite state machine, a computer coupled to a memory containing a program system, an inferential engine and/or a neural network. The apparatus may further include a computer readable memory, a disk drive and/or a server, each configured to deliver the program system and/or an installation package to the processor-unit to implement at least part of the disclosed method and/or apparatus. These delivery mechanisms may be controlled by an entity directing and/or benefiting from the delivery to the processor-unit, irrespective of where the server may be located, or the computer readable memory or disk drive was written.

The disclosed method may include steps initializing at least one of the disclosed apparatus, and/or operating at least one of the apparatus and/or using at least one of the apparatus to create any combination of the vibration report, the vehicle parameter, the vehicle classification, the vehicle travel record, the traffic ticket message, the tariff message and/or the insurance message. The method may produce any of the vibration report, the vehicle parameter, the vehicle classification, the vehicle travel record, the traffic ticket message, the tariff message and/or the insurance message.

Regarding the Third Aspect:

In the prior art, there is a discussion that radar transmission signals in multi-GigaHerz (GHz) bands that are unaffected by changing weather conditions. While this is true, the prior art overlooks some issues that the inventor has had to cope with. The inventor has found each of the following issues to seriously affect at least some installations of micro-radar:
Different manufacturing runs may significantly alter the operating characteristics of the micro-radar, even in a laboratory setting.
Varying temperature/weather conditions may significantly alter the operating characteristics.
Varying ground conditions for a micro-radar embedded in the ground may significantly alter the operating characteristics.
The micro-radar components may also drift over time even when there are little or no changes in the weather or ground conditions. The component drift may also significantly alter the operating characteristics.
Often, there may be variations in the noise in the Intermediate Frequency (IF) signal that can compromise the detection and/or distance estimate of an object.

These operating characteristics of the micro-radar may include changes in the IF signal frequency and/or the micro-radar and/or changes in the timing delays of the receiver. Changes in either or both of these characteristics can adversely affect a sensor's ability estimate the travel time of the radar pulse and from that render the distance estimate to an object less accurate.

The application discloses and claims several embodiments, a micro-radar, sensor nodes adapted to interact with the micro-radar, processors responding to the micro-radar, as well as systems and components supporting communications between the micro-radars and the processors. The processors and systems may further support traffic analysis and management of moving and/or stationary vehicles. The vehicles may include sections of non-magnetic materials such as aluminum, wood and/or plastics that tend to create false readings for magnetic sensors. The processors and systems may also support management of production processes such as chemical production, device fabrication and container filling of various items such as liquids, grains and/or saw dust.

The micro-radar will refer to a radar adapted to generate an antenna output of less than or equal to ten milli-Watts (mW). The micro-radar is adapted to operate in response to at least one output of a Digital to Analog Converter (DAC) and sometimes preferably two DAC outputs.

The DAC output may be used to generate an analog sum including an exponentially changing signal and the output of the DAC. Here are two examples of the response of the micro-radar to distinct analog sums, either or both of which may be incorporated into the micro-radar and/or its operations:
First, the micro-radar may operate in response to a first analog sum of a first DAC output, an exponentially changing signal, and a clock signal. The response may include generating a receiver mixing signal that is asserted at a succession of time delays that are a function of the first analog sum.
Second, the micro-radar may be operated based upon a second analog sum of a second exponentially changing signal and a second DAC output to control the IF frequency of the down converted received RF reflection. The second analog sum may control a duty cycle of a pulse generating oscillator output without changing its frequency. The duty cycle may be measured as the high time divided by the period of the oscillator output.

The micro-radar may include a RF transceiver/mixer RFTM used to generate carrier signal for the antenna output and to generate the received IF signal.

The micro-radar may be operated through the control of the first and/or second DAC outputs. Some operations that may be supported include any combination of the following:
Controlling both the first and second DAC outputs to advance or retard the sweep time with respect to the distance to the object.
Setting the second DAC output to generate the IF signal as a noise reading.
And calibrating the first DAC output to establish the IF frequency.

The apparatus may further include a wireless sensor node and/or a wireline sensor node and/or a processor and/or an access point and/or a server.
The wireless sensor node may include a first instance of the micro-radar and a radio transceiver configured to send a report regarding the sweep time for the object.
The wireline sensor node may be configured to operate a second instance of the micro-radar and including a wireline interface configured to send the report regarding the sweep time for the object.
The processor may be configured to receive the report and configured to respond to the report by generating an estimate of the distance of the object from the micro-radar.
The access point may be configured to wirelessly communicate with the micro-radar via the radio transceiver to send a version the report to the processor.
And the server may be configured to communicate the version of the report from the micro-radar to the processor.

The wireless sensor node and/or the wireline sensor node may further include a sensor processor configured to control the micro-radar by at least control of the first DAC output and the second DAC output.

At least one of the sensor processor, the access point, the server and/or the processor includes at least one instance of at least one of a finite state machine and a computer accessibly coupled to a memory containing a program system comprised of program steps configured to instruct the computer.

Various implementations of the program system may include at least one of the program steps of:
Operating the micro-radar based upon control of the first DAC output and/or the second DAC output.
Receiving the IF signal to generate an ADC reading and/or the sweep time for the object.
Generating the report based upon the ADC reading and/or the sweep time.
Responding to the report by sending the version of the report to the processor.
Second responding to the report and/or the version to generate the distance of the object from the micro-radar.
Third responding to the report and/or the version to generate a size of the object.
And/or fourth responding to the distance of the object from the micro-radar by updating at least one of a traffic monitoring system, a traffic control system, a parking management system, and/or a production management system.

The apparatus may further include at least one of the traffic monitoring system, the traffic control system, the parking management system, and/or the production management system, any of which may include
At least one communicative coupling to at least one of the micro-radar, the wireless sensor node, the wireline sensor node, the processor, the access point and/or the server.
The communicative coupling(s) may support communication across at least one of a wireline physical transport and/or a wireless physical transport.

### BRIEF DESCRIPTION OF THE DRAWINGS

The three aspects of this disclosure are shown as follows: The first aspect is shown through FIGS. 1 to 19B. The second aspect is shown through FIGS. 20 to 33. The third aspect is shown through FIGS. 34 to 44.

FIG. 1 shows an example of the first set of embodiments implementing a wireless sensor network using embodiments of two apparatus. The first apparatus is embodied in at least two of the wireless sensor nodes include a processor that generates an improved estimate and/or an improved time stamp that emulates at least doubling the sensor sampling rate. The second apparatus includes a second processor, that may use the improved sensor estimates and/or improved time stamps to generate any combination of a parameter of a vehicle, a movement estimate of the vehicle, and/or a traffic ticket message, any of which may be sent to a traffic speed enforcement system. In this example, the access point includes the second apparatus and its second processor.

FIG. 2A shows the sensor readings may be distributed evenly throughout the time unit.

FIG. 2B shows the sensor readings may be distributed unevenly throughout the time unit.

FIG. 3 shows some details of the sensors that may be used in the wireless sensor nodes.

FIG. 4 shows the improved estimate may include an improved sensor reading and/or an improved reading characteristic, which may include edge estimates, and/or extrema estimates, and/or frequency domain estimates.

FIGS. 5A and 5B show some details of the signal processing that the processor may be configured to perform in terms of filtering the sensor readings to create at least part of the improved sensor readings and/or the improved reading characteristics.

FIGS. 6A to 6C show some details of the wireless sensor network of FIG. 1 composed of wireless sensor nodes that use the sensor that includes the magnetic sensor.

FIG. 7 shows the processor may be further configured to create at least one reading characteristic based upon the improved readings and/or the improved time stamps and that the wireless sensor node may include a transmitter and/or a receiver possibly employing various carrier bands and/or various communication schemes and/or compliant with various communications protocols.

FIG. 8 shows the processor may implement at least one of several means for performing various disclosed operations of the first apparatus.

FIG. 9 shows the processor and/or at least one of its means may include at least one instance of a finite state machine, a computer and/or an accessible memory including a program system configured to instruct the computer in accord with this disclosure. The Figure also shows an installation device, a server and/or a computer readable memory that may be configured to deliver an installation package and/or the program system and/or a finite state machine configuration.

FIGS. 10A to 10C show some details of the program system and/or operating the finite state machine as at least part of, at least one of, the shown steps of operating the apparatus.

FIG. 11 shows the improved sensor reports of the two sensor nodes of FIG. 1 and some examples of the information these improved sensor reports may deliver to the second apparatus and the second processor.

FIG. 12 shows the access point may not contain the second apparatus as shown in FIG. 1. But the second apparatus may be included in a second circuit board and/or a second integrated circuit similarly to FIG. 1. Some details of the second processor, the vehicle parameter and the movement estimate are also shown.

FIG. 13 shows the second apparatus may further include a removable interface coupling to the coupled to the second processor. The second processor may be further configured to use the removable interface to receive the improved sensor report and to send the movement estimate and/or the traffic ticket message, either through the access point as shown in FIG. 1 or directly to other systems such as the traffic enforcement system as shown in this Figure. The second processor is also shown including at least one of several means for operating the second apparatus.

FIG. 14 is similar to FIG. 9 and shows the second processor and/or means of FIG. 13 may include at least one implementation of at least one of a second finite state machine, a second computer and a second accessible memory including a second program system configured to instruct the second computer. A second installation device, a second server and/or a second computer readable memory are also shown.

FIG. 15 shows a flow chart of the second program system includes, and/or the operations the second finite state machine is configured to support, as at least part of, at least one of, the shown steps of operating the second apparatus.

FIG. 16 shows a second set of embodiments as a third apparatus including a third processor that may be included in a third integrated circuit and/or a third circuit board and/or an access point configured to communicate with wireless sensor nodes that do not emulate increasing the sampling frequency of their sensors. The third apparatus and/or the third processor provide the wireless sensor network an emulation of increased sampling frequency.

FIG. 17 shows another embodiment of the third apparatus that is not included in the access point but may be included in a third circuit board and/or a third integrated circuit. Some details of the third processor are shown indicating means for filtering sensor reading estimates

FIG. 18 shows the third apparatus including a removable interface coupling and the third processor and/or at least one of its means including at least one instance of a third finite state machine and/or a third computer and/or a third accessible memory possibly containing a third program system and/or a third installation package. This set of embodiments may include the second installation device and/or the second server and/or a second computer readable memory as previously discussed with regards the second apparatus.

FIGS. 19A and 19B show some details of the third program system and/or the operations of the third finite state machine which are similar to a merger of the operations of the first processor and second processor with the main difference being that the third processor starts with sensor reading estimates and the first processor starts with the sensor readings.

FIG. 20 shows an example second system operating and/or using a wireless sensor network that may include at least one access point configured to wirelessly communicate with at least one embedded wireless vibration sensor node embedded in pavement with a vehicle traveling on the pavement inducing vibrations by the deflection of the pavement. The access point receives a vibration report in response to the vibration readings of the vehicle traveling on the pavement. The second system may further produce at least one vehicle parameter, a vehicle classification, a vehicle travel record, a traffic ticket message, a tariff message and/or an insurance message.

FIGS. 21A and 21B show examples of how the vehicle parameters may be alternatively defined by different implementations of the second system and its components of FIG. 20.

FIGS. 22A and 22B show examples of how the second system and its components of FIG. 20 may implement and/or use the vehicle parameter.

FIG. 22C shows some details of certain implementations of the weight estimate.

FIG. 23 shows some example implementations of components that may be used and/or included in the embedded wireless vibration sensor node embedded in the pavement shown in FIG. 20.

FIG. 24 shows an example of the embedded wireless vibration sensor node further including the fifth processor and the seventh processor, with the vibration report further indicating the vehicle parameter and the vehicle classification.

FIGS. 25 and 26 show examples of various combinations of the second through the ninth processor may be implemented in the access point.

FIG. 27A shows an example of the second system of FIG. 20 further including more than one instances of the embedded wireless vibration sensor nodes embedded in the pavement of a lane of a roadway. The second system may further include one or more wireless magnetic sensor node also embedded in the pavement.

FIGS. 27B and 27C show some other examples of the second system of FIGS. 20 and 27A that may also determine the axle width for a vehicle with two axles, as well as possibly further include radar, infrared sensors and/or optical sensors. The second system may also include a temperature sensor that may or may not be implemented in the embedded wireless vibration sensor nodes.

FIG. 28 shows the processors may be individually and/or collectively may be implemented as one or more instances of a processor-unit. The apparatus may further include delivery mechanisms that may be controlled by an entity directing and/or benefiting from the delivery to the processor-unit of the second program system and/or an installation package to implement at least part of the disclosed method and/or apparatus.

FIGS. 29 to 33 show some details of the second program system of FIG. 28 that may serve as examples for at least some of the steps of the disclosed method.

FIG. 34 shows a simplified block diagram of an example of a wireless sensor node and/or a wireline sensor node that may include a sensor processor configured to operate a micro-radar based upon a first DAC output and second DAC output.

FIG. 35A shows a timing diagram of the relationship between the sweep clock, the transmit signal and the reception signal as generated by the timing generator and used by the RFTM of FIG. 34, including the time delay between the signals and/or the pulses, the pulse widths and duty cycle.

FIG. 35B shows a timing diagram sweep of the time delay from a short delay to a long delay over a time interval, as well as the IF signal over the time interval with a peak amplitude at a sweep delay Tm corresponding to the distance T0 of the object from the antenna as shown in FIG. 34.

FIG. 36 shows some details the micro-radar, in particular the timing generator of FIG. 34, including a transmit control generator responding to the first DAC output and a reception control generator responding to the second DAC output.

FIG. 37 shows the first sharp threshold device and/or the second sharp threshold device of FIG. 3 may include at least one instance of a logic gate, a comparator and/or a level shifter.

FIG. 38 shows an example of the RFTM of FIG. 34 based upon the circuitry of U.S. Pat. No. 6,414,627 (hereafter referred to as the '647 patent).

FIG. 39 shows some examples of the object as at least one of a person, a bicycle, a motorcycle, an automobile, a truck, a bus, a trailer and/or an aircraft.

FIG. 40 shows some examples of the object as a surface of a filling of a chamber.

FIG. 41 shows some other apparatus embodiments that involve the micro-radar of FIG. 34, including but not limited to, the wireless sensor node and the wireline sensor node, sending message based upon the estimate sweep delay. A processor may respond to the messages to generate an estimated distance approximating the distance T0 of the radar antenna from the object. Access points and/or servers may include the processor and/or share communications between the sensor nodes and/or the micro-radars and/or the processors.

FIG. 42 shows some details of at least one of the sensor processor and/or the processor of FIG. 41 may be individually and/or collectively may be implemented as one or more instances of a processor-unit that may include a finite state machine, a computer, a program system, an inferential engine and/or a neural network. The apparatus may further include examples of a delivery mechanism, which may include a computer readable memory, a disk drive and/or a server, each configured to deliver the program system and/or an installation package to the processor-unit to implement at least part of the disclosed method and/or apparatus.

FIG. 43 shows a flowchart of the program system of FIG. 41.

FIG. 44 shows a simplified network diagram of various systems that may communicate with the micro-radars and/or the wireless sensor node and/or the wireline sensor node and/or the processor and/or the access point and/or the server of FIG. 41. The various systems include but are not limited to a traffic monitoring system, a traffic control system, a parking management system and/or a production management system.

### DETAILED DESCRIPTION OF DRAWINGS

This disclosures has three aspects. The first aspect relates to signal estimation for wireless sensor nodes that operate sensors with batteries. The invention emulates increasing the sampling frequency with little or no additional drain on the batteries. The invention also relates to using these improved sensor readings to generate vehicle parameters such as length, number of axles, and axle positions, movement estimates such as velocity and acceleration, and traffic ticket messages based upon the movement estimates and/or the vehicle parameters. Any combination of these parameters, estimates and/or messages may be sent to other systems.

The second aspect relates to second systems that use a wireless sensor network including vibration sensor nodes embedded in pavement. The invention also relates to second systems that use vibration readings to generate vehicle parameters such as vehicle length, the number, positions and/or spacing of some or all of the axles of the vehicle, which may be used to generate a vehicle classification. The second system may also monitor the weight of vehicles passing over or near them on a lane to assess the pavement damage of the lane.

The third aspect relates to micro-radars, radar antennas, sensor nodes adapted to interact with a micro-radar, and processors adapted to respond to the micro-radar, as well as components and systems supporting communications between the micro-radars and the processors. The processors and systems may further support traffic analysis and management of moving and/or stationary vehicles. In some embodiments the micro-radar, sensor nodes, processors and/or system may support production management.

Regarding the First Aspect of this Disclosure:

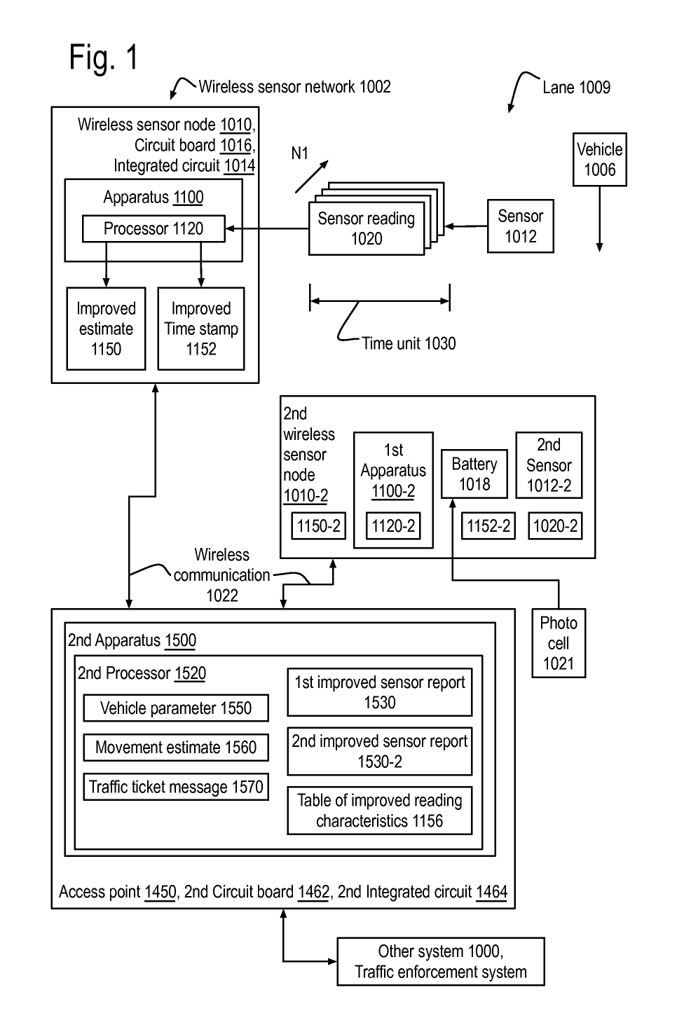

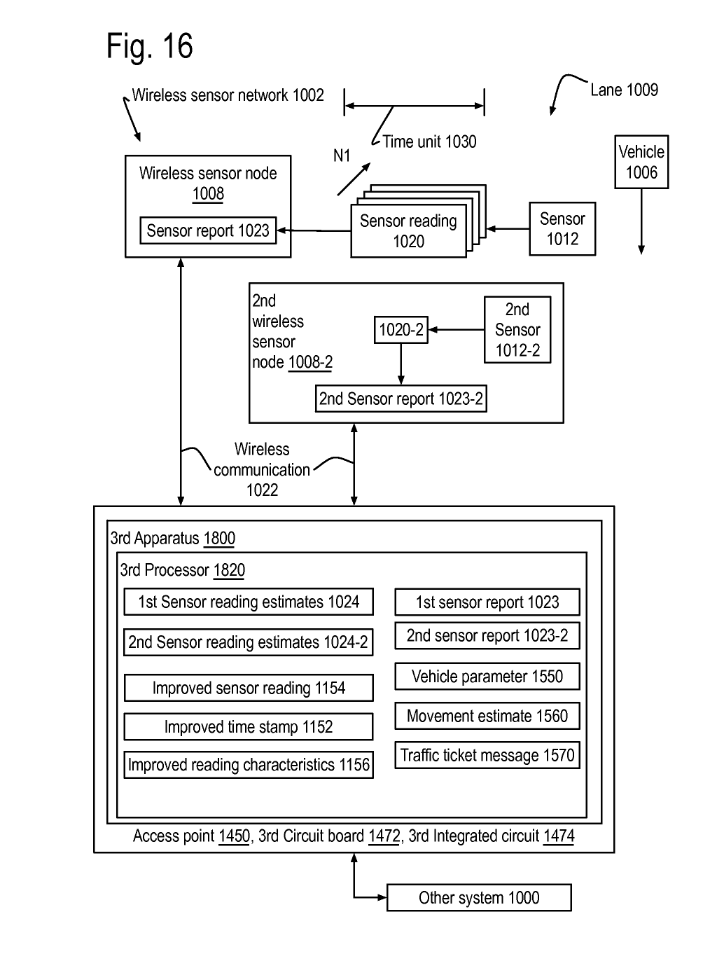

Two sets of embodiments are disclosed. The first set includes a first apparatus 1100 and possibly a second apparatus 1500 as shown beginning in FIG. 1. Disclosure of a second set of embodiments that may include a third apparatus 1800 with a third processor 1820 begins in FIG. 16.

FIG. 1 shows an example of a wireless sensor network 1002 using embodiments of two apparatus 1100 and 1500.

The first apparatus 1100 is configured for use with a first wireless sensor node such as 1020 and 1020-2 and includes a processor 1120. The processor 1120 may be configured to receive a sensor reading 1020, N1 times per time unit 1030, generated by a sensor 1012, where N1 may be at least two. The processor generates an improved estimate 1150, and/or an improved time stamp 1152. The improved estimate 1150 and/or the improved time stamp 1152 emulates the sensor readings 1020 received at an increased sampling frequency. The increased sampling frequency may be at least twice the N1 times per time unit 1030.

The second apparatus 1500 may include a second processor 1520, that may use the improved sensor estimates 1150 and/or improved time stamps 1152 to generate any combination of a parameter 1550 of a vehicle 1006, referred to herein as a vehicle parameter 1550, a movement estimate 1560 of the vehicle 1006, and/or a traffic ticket message 1570, any of which may be sent to other systems such as a traffic speed enforcement system 1000 across any combination of wireless and wireline physical transports, such as Local Area Networks (LAN) and/or Wireless LANs (WLAN).

Some details regarding the first apparatus 1100 will be discussed first, followed by a discussion of some details regarding the second apparatus 1500.

The wireless sensor network 1002 may include at least one of the first wireless sensor nodes 1010 and 1010-2 wirelessly communicating with at least one access point 1450.
The first first wireless sensor node 1010 may include the first instance of the first apparatus 1100 that further includes the first instance of the processor 1120. The first processor 1120 may be configured to respond to the sensor readings 1020 generated by the sensor 1012, N1 times per time unit 1030 to create at least one improved estimate 1150 and/or at least one improved time stamp 1152.
The second first wireless sensor node 1010-2 may include the second instance of the first apparatus 1100-2 that further includes the second instance of the processor 1120-2. The processor 1120-2 may be configured to respond to the sensor readings 1020-2 generated by the sensor 1012-2 N1 times per time unit 1030 to create at least one improved estimate 1150-2 and/or at least one improved time stamp 1152-2.

N1 may be at least two and may be larger, for instance it may be 128 for the time unit 1030 of one second in some embodiments. In other embodiments, the N1 may be a different number, such as 1024. The time unit may include multiples of a second and/or fractions of a second. The time unit 1030 may also be in terms of minutes, hours and/or days in certain embodiments.

Various configurations of the first wireless sensor node 1020 and/or 1020-2 may be embodied. The first wireless sensor 1012 may communicate with the first wireless sensor node 1010, but may not be included in the first wireless sensor node 1010, whereas the second sensor 1012-2 may be included in the second first wireless sensor node 1010-2.

The second first wireless sensor node 1020-2 is shown including a battery 1018 that may be used to provide power for the apparatus 100-2 and/or the processor 120-2. The battery 1018 may be configured to receive power from one or more photo-voltaic cells 1021.

At least one of the first wireless sensor nodes, for example the second first wireless sensor node 1010-2, may include the apparatus 1100-2 and a battery 1018 configured to provide electrical power to the apparatus 1100-2. The battery 1018 may be configured to receive power from at least one photovoltaic cell 1021.

In certain implementations of the wireless sensor network 1002, the first wireless sensor nodes 1010 and 1010-2 may be embedded in the pavement Pv1 of a lane 1009 of a roadway, as further shown in FIGS. 6B and 6C hereafter.

FIG. 1 further shows the second apparatus 1500 may configured to use wireless communication 1022 with the first wireless sensor nodes 1010 and 1010-2 to use their improved estimates 1150 and/or their improved time stamps 1152. The second apparatus 1500 includes a second processor 1520 may use the improved sensor estimates 1150 and/or the improved time stamps 1152 to generate any combination of a parameter of a vehicle 1006, referred to herein as a vehicle parameter 1550, a movement estimate 1560 of the vehicle 1006, and/or a traffic ticket message 1570, any of which may be sent to other systems such as a traffic speed enforcement system 1000.

An integrated circuit 1014 and/or a circuit board 1016 may include the apparatus 1100. And a second circuit board 1462 and/or a second integrated circuit 1464 may include the second apparatus 1500. Note that in some embodiments, a single integrated circuit 1014 may be configured to perform as the first apparatus 1100 and/or as the second apparatus 1500.

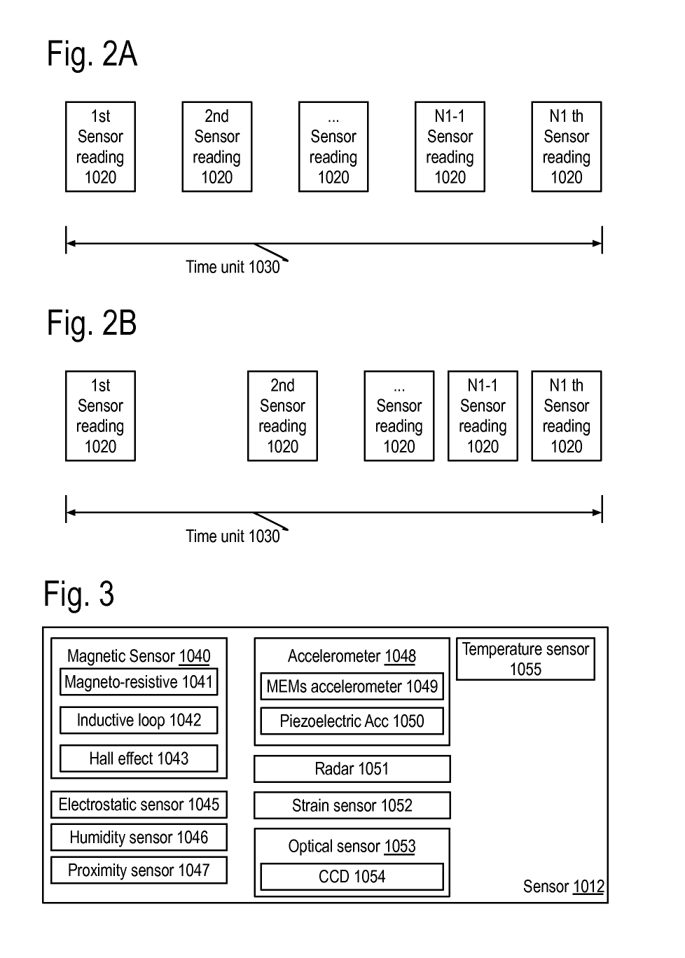

FIG. 2A shows the sensor readings 1020 may be distributed evenly throughout the time unit 1030. And FIG. 2B shows the sensor readings 1020 may be distributed unevenly throughout the time unit 1030.

FIG. 3 shows that at least one instance the sensor 1012 may include at least one of a magnetic sensor 1040, an electrostatic sensor 1045, a humidity sensor 1046, a proximity sensor 1047, an accelerometer 1048, a radar 1051, a strain sensor 1052, an optical sensor 1053 and/or a temperature sensor 1055. The magnetic sensor 1040 may include at least one of a magneto-resistive sensor 1041, an inductive loop 1042, and/or a Hall sensor 1043. The accelerometer 1048 may include a MEMs accelerometer 1049 and/or a piezoelectric accelerometer 1050. The optical sensor 1053 may include a Charge Coupled Device (CCD) 1054.

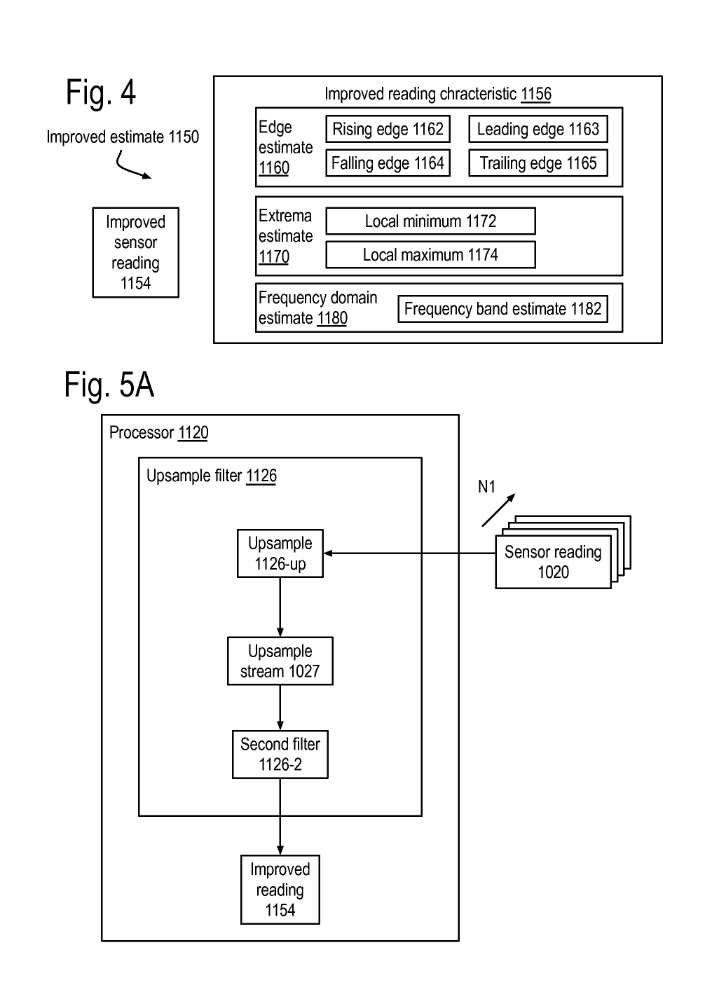

FIG. 4 shows the improved estimate 1150 may include an improved sensor reading 1154 and/or an improved reading characteristic 1156. The improved reading characteristic 1156 may include an edge estimate 1160, an extrema estimate 1170, and/or a frequency domain estimate 1180. The edge estimate 1160 may indicate a rising edge 1162 or a falling edge 1164. In other embodiments, the extrema estimate 1160 may indicate a leading edge 1163 and/or a trailing edge 1165. The extrema estimate 1170 may indicate a local minimum 1172 or a local maximum estimate 1174. The frequency domain estimate 1180 may include at least one frequency band estimate 1182.

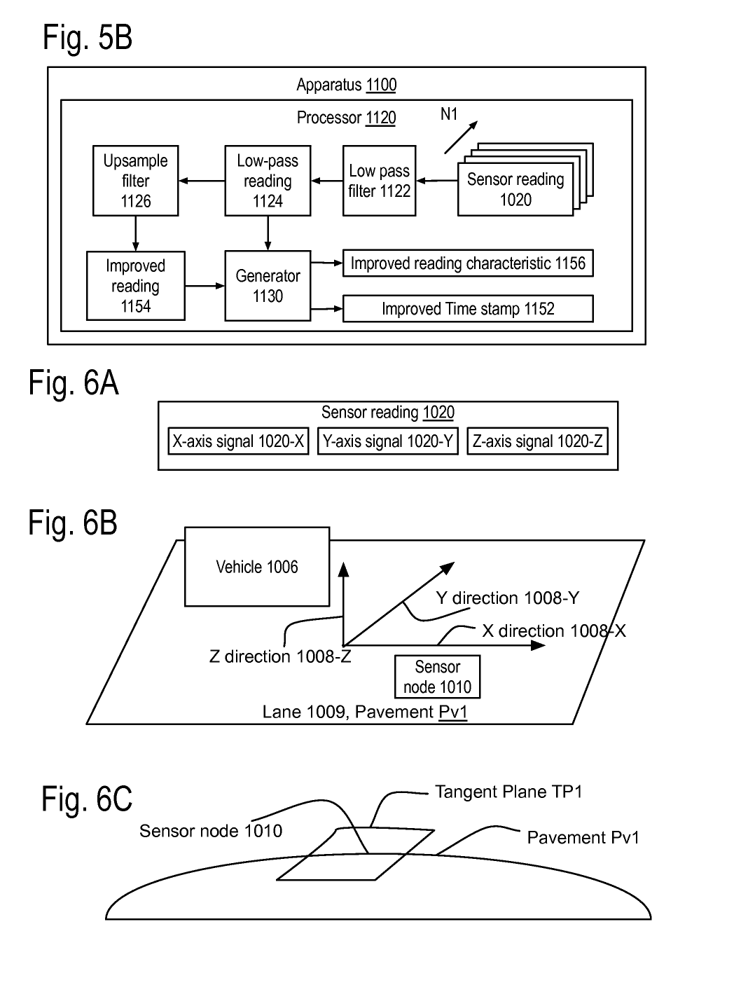

FIGS. 5A and 5B show some details of the signal processing that the processor 1120 may be configured to perform in terms of filtering the sensor readings 1020.

FIG. 5A shows the processor 1120 of FIG. 1 may be further configured to upsample filter 1126 the sensor readings 1020 to generate the improved sensor reading 1154. As used herein, an upsample filter 1126 generates more samples output than sample inputs 1020. In some contexts, the upsample filter may be decomposed into upsampling 1126-up and a second filtering 1126-2 at least part of the upsampled data 1027 stream to emulate increasing the sampling frequency without having to operate the sensor 1012 more often.

As used herein, the upsampled filter 1126 may perform an up-sampling 1126-up of an input stream 1020 to create an up-sampled data stream 1027 used by a second filter 1126-2 to generate the output of the upsampled filter 1126.
Up-sampling 1126-up that may be implemented in a variety of ways.
   For example, each input sample may be replicated one or more times.
   Another example, each input sample may have a fixed value, such as zero inserted between it and the next input sample.
   Another example, the input sample may be inserted between a running and/or windowed average of the input stream.
The second filter 1126-2 may be composed of two or more subband filters whose outputs are sub-sampled so that the output rate of the second filter 1126-2 may be the same the up-sampled input stream rate 1027, which may then be twice or more times the input stream 1020 rate of the upsampled filter 1126.

FIG. 5B shows a refinement of FIG. 5A, the processor 1120 may include a low pass filter 1122 receiving at least part of the sensor readings 1020 to generate a low pass reading 1124. At least some of the low pass readings 1124 may be used by the upsample filter to at least partly, further generate the improved sensor reading 1154. The low pass reading 1124 and/or the improved sensor reading 1154 may be used to generate 1130 the improved reading characteristic 1156 and/or the improved time stamp 1152.

Consider an example of the wireless sensor network 1002 of FIG. 1 composed of first wireless sensor nodes 1010 that use a sensor 1012 that includes a magnetic sensor 1040 to be shown and discussed in FIGS. 6A to 6C. The magnetic sensor 1040 may further include at least one magneto-resistive sensor 1041.

FIG. 6A shows an example of the sensor reading 1020 generated by a magnetic sensor 1040, in particular, a magneto-resistive sensor 1041, that may include at least two of a magnitude in an X axis direction 1008-X, referred to as the X magnitude 1020-X, a magnitude in a Y axis direction 1008-Y, referred to as the Y magnitude 1020-Y, and a magnitude in a Z axis direction 1008-Z, referred to as the Z magnitude 1020-Z.

FIG. 6B shows an example of the first wireless sensor node 1010 embedded in the pavement Pv1 of a lane 1009 that is essentially flat showing the X axis direction 1008-X, the Y axis direction 1008-Y, and the Z axis direction 1008-Z, by which the movement of the vehicle 1006 may be estimated.

FIG. 6C shows an example implementation where the pavement Pv1 is not flat and the local reference plane for the axes of FIG. 6B becomes the tangent plane (TP1) of the pavement in the neighborhood of the first wireless sensor node 1010.

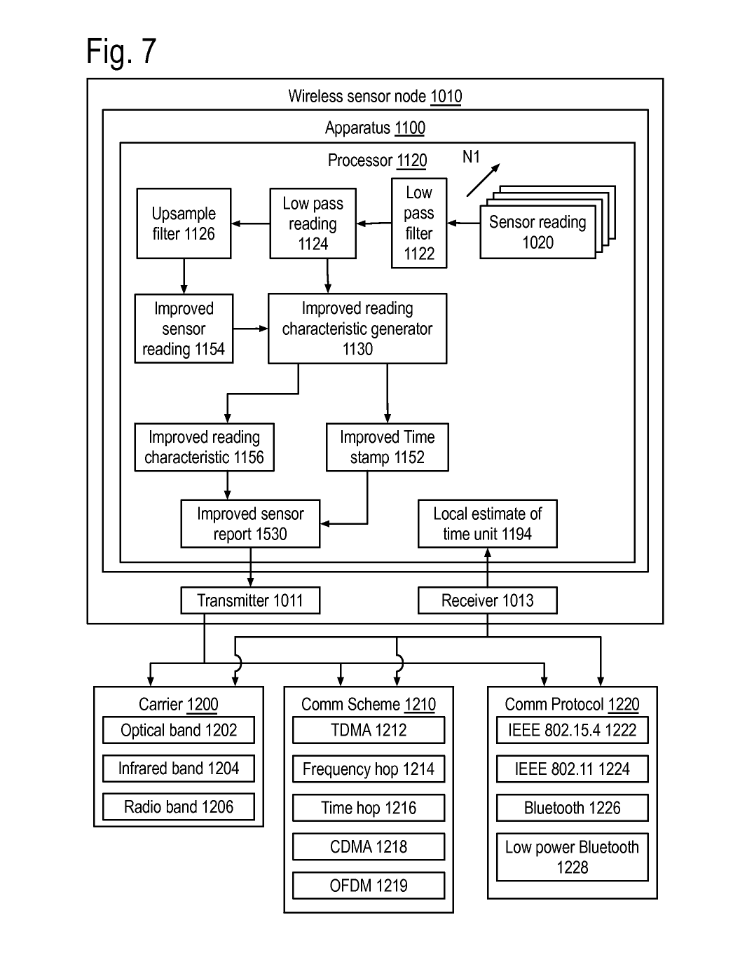

FIG. 7 shows the processor 1120 may be further configured to create at least one of the improved reading characteristics 1156 based upon the improved sensor readings 1154 and/or the improved time stamps 1152. The processor 1120 may include an improved reading characteristic generator 1130 the may receive at least some of the improved sensor readings 1154 and/or at least some of the low pass readings 1124 to create at least some of the improved reading characteristics 1156 and/or the improved time stamps 1152. An improved sensor report 1530 may be constructed based upon the improved estimates 1150, possibly based upon the improved reading characteristics 1156 and/or based upon the improved time stamps 1152.

For example, the improved reading characteristic generator 1130 may only produce improved edge estimates 1160. Whereas in other embodiments the improved reading characteristic generator 1190 may only produce improved extrema estimates 1170. And in yet other embodiments, improved reading characteristic generator 1130 may only produce improved frequency domain estimates 1180.

As used herein, a low pass filter is a filter that is configured to pass with little or no resistance a low frequency signal component and to attenuate or resist a frequency component above a cut-off frequency. Some implementations of low pass filters are implemented in digital forms. One particular form of a digital implementation of the first filter 1122 as a low pass filter may average the preceding K1 digital readings 1020 to create the first-filtered reading 1124, where a value of K1 is at least two and may be preferred to be at least four for N1=128 samples in the time unit 1030 of one second.

The apparatus 1100 may be configured to use a transmitter 1011 to transmit at least the improved sensor report and/or to use a receiver 1013 to synchronize the first wireless sensor node 1010 to maintain a local estimate of the time unit 1194. The transmitter 1011 and/or the receiver 1013 may use various communication schemes and/or communication protocols.

The transmitter 1011 and/or the receiver 1013 may use a carrier 1200 in an optical band 1202 and/or an infrared band 1204 and/or a radio band 1206.

The transmitter 1011 and/or the receiver 1013 may use one or more communication schemes 1210, for instance a Time Division Multiple Access (TDMA) scheme 1212, a Frequency hopping scheme 1214, a time hopping scheme 1216, a code division multiple access (CDMA) scheme 1218 and/or an Orthogonal Frequency Division Modulation (OFDM) scheme 1219.

The transmitter 1011 and/or the receiver 1013 may be compatible with a version of a wireless communication protocol 1220, such as an Institute for Electrical and Electronic Engineers (IEEE) 802.15.4 protocol 1222, an IEEE 802.11 protocol 1224, a Bluetooth protocol 1226 and/or a Bluetooth low power protocol 1228.

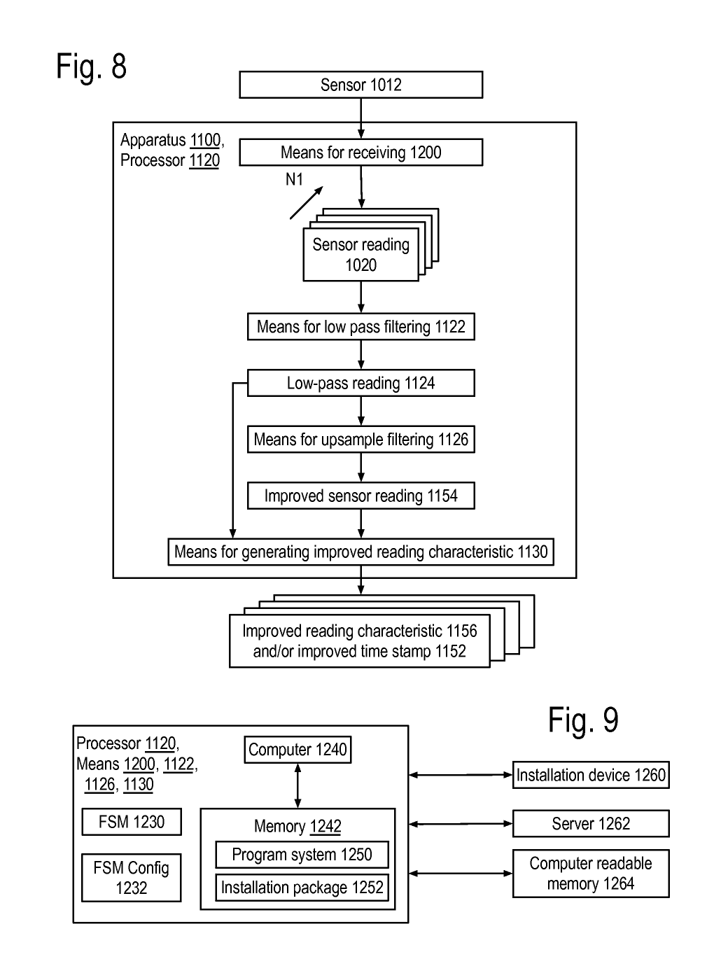

FIG. 8 shows the processor 1120 may implement at least one of several means for performing various disclosed operations of the apparatus 1100. By way of example, the sensor 1012 may communicate with a means for receiving 1200 to generate the sensor readings 1020. A means for low pass filtering 1122 may respond to the received sensor readings 1020 to generate the low-pass reading 1124. A means for upsample filtering 1126 may respond to the low pass reading 1124 to generate the improved sensor reading 1154. A means for generating 1130 may respond to the improved sensor reading 1154 and possibly to the low pass reading 1124 to generate at least one improved reading characteristic and/or at least one improved time stamp 1152.

The processor 1120 may employ a fuzzy engine and/or a genetic algorithm to at least partly implement generation of the improved time stamp 1152 and/or the improved sensor reading 1154 and/or the improved reading characteristic 1156. While such implementations are within the scope of the claimed invention, it should be noted that such implementations typically use Finite State Machines and/or computers, which will now be shown.

FIG. 9 shows the processor 1120 and/or at least one of the means 1200, 1122, 1126, 1130 may include at least one instance of a finite state machine 1230, a computer 1204 and/or an accessible memory 1242 including a program system 1250 configured to instruct the computer 1240 in accord with this disclosure.

FIG. 9 also shows the apparatus disclosed and claimed to include an installation device 1260 and/or a server 1262 and/or a computer readable memory 1264, any or all of which may be configured to deliver to the processor 1120, the computer 1240 and/or the memory 1242 at least part of the program system 1250 and/or the installation package 1252.

As used herein, a FSM 1230 may be configured to receive at least one input, maintain at least one state and generate at least one output in response to a value of at least one of the inputs and/or in response to the value of at least one of the states. The FSM configuration 1232 may be used to configure the FSM 1230 implemented by a programmable logic device, such as a Field Programmable Gate Array (FPGA) to at least partly implement the disclosed apparatus.

As used herein, the computer 1240 may include at least one instruction processor and at least one data processor with at least one of the instruction processor instructed by at least one of the instruction processors in response to the program system 1250, possibly through accesses of the memory 1242 by the computer 1240.

As used herein, the installation package 252 may be configured to instruct the computer 1240 to install the program system 1250 and/or may be configured to instruct the computer and/or the FSM 1230 to install the FSM configuration 1232.

As used herein, the memory 1242 and/or the computer readable memory 1264 may include at least one instance of a volatile and/or a non-volatile memory component. A volatile memory component tends to lose its memory contents without a regular supply of power, whereas a non-volatile memory component tends to retain its memory contents without needing such a regular supply of power.

The computer readable memory 1264 and/or the server 1262 and/or the installation device 1260 may include various communications interfaces to deliver the program system 1250, the installation package 1252, and/or the FSM configuration 1232: a Bluetooth interface, and/or a Wireless LAN (WLAN) interface, and/or some combination of these and possibly other interfaces.

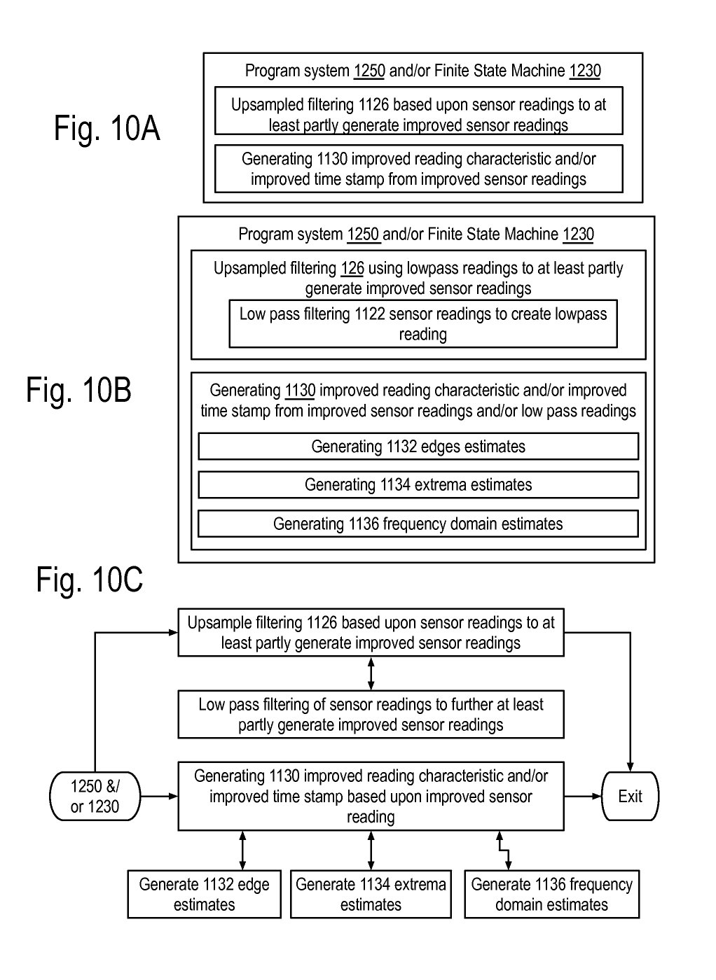

FIG. 10A shows some details of various embodiments of the program system 1250 and/or the operation of the finite state machine 1230 disclosing some details of the method of operating the various examples of the apparatus that may include the processor 1100 of the previous Figures the first apparatus 1100 as steps performed by its processor 1120 and/or implemented by the finites state machine 1230.

FIG. 10B shows a flowchart of the program system 1250 implementing a first specific example of the processor 1120 operating the apparatus 1100 configured to receive the sensor readings 1020 as shown in FIG. 5A:
The sensor readings 1020 include magnetic signals mag(Z) 1020-Z and mag(X) 1020-X. The sensor readings 1020 are filtered by the low pass filter 1122 to generate the first-filtered readings 1124 as first-mag(Z) and first-mag(X).
The first filtered readings 1124 may be passed through generator 1132 of edge estimates to generate the edge estimates 1160.
The low pass filtered first-mag(Z) readings may be upsample filtered 1126 to generate the improved sensor reading 1154 as a second-mag(Z) readings.
   As previously stated, upsampled filters 1126 may be considered to include an up-sampling process and a second filter process. There are several variations of the upsampling which have already been discussed.
   In some implementations, the second-filter 1126-2 may employ nine taps. The tap values may be near the following vector in either a fixed point, floating point or logarithmic format: [−0.021359, −0.076633, −0.047043, 0.167437, 0.415379, 0.415379, 0.167437, −0.047043, −0.076633]. Alternatively, a different tap vector may be employed, which may or may not be near this example tap vector.
   In other implementations, the second-filter 1126-2 may employ a different number of taps, possibly greater than 9.
Generating 130 the improved reading characteristic 1156 and/or the improved time stamp 1152 based upon the improved sensor reading 1154 may include any combination of the following:
   The improved sensor readings 1154 may be presented to a edge estimator 1132 to generate one or more of the edge estimates 1160.
   The improved sensor readings 1154, for instance the second-mag(Z) 1154-Z readings, may be presented to a generator 1134 of extrema estimates to generate the extrema estimates 1170.
   The improved sensor readings 1154 may be presented to a band pass filter 1136 to generate the frequency domain estimate 1180.

FIG. 10C shows a flowchart view of the program system 1250 and/or the operations of the finite state machine 1230 as a different view of the material shown in FIGS. 10A and 10B.

There are some things to note about FIGS. 10A to 10C. In program optimization of the program system 1250, particularly as such code is often triggered as a response to a real-time interrupt of the computer 1240, the various process steps tend to be merged more in the spirit of FIGS. 10A and 10B. However, in terms of the design and analysis of the operations of the processor 1120 and/or the apparatus 1100, FIG. 10C is closer to the spirit of the research and initial specification for the development of the program system 1250 and/or its implementation in terms of the means 1130 for generating the improved estimate 1150 and/or improved time stamp 1152 of FIG. 8.

The improved estimates 1150 and/or the improved time stamps 1152 are then packaged into the improved sensor report 1530 shown in FIG. 7 for transmission to the access point 1450 of FIG. 1.

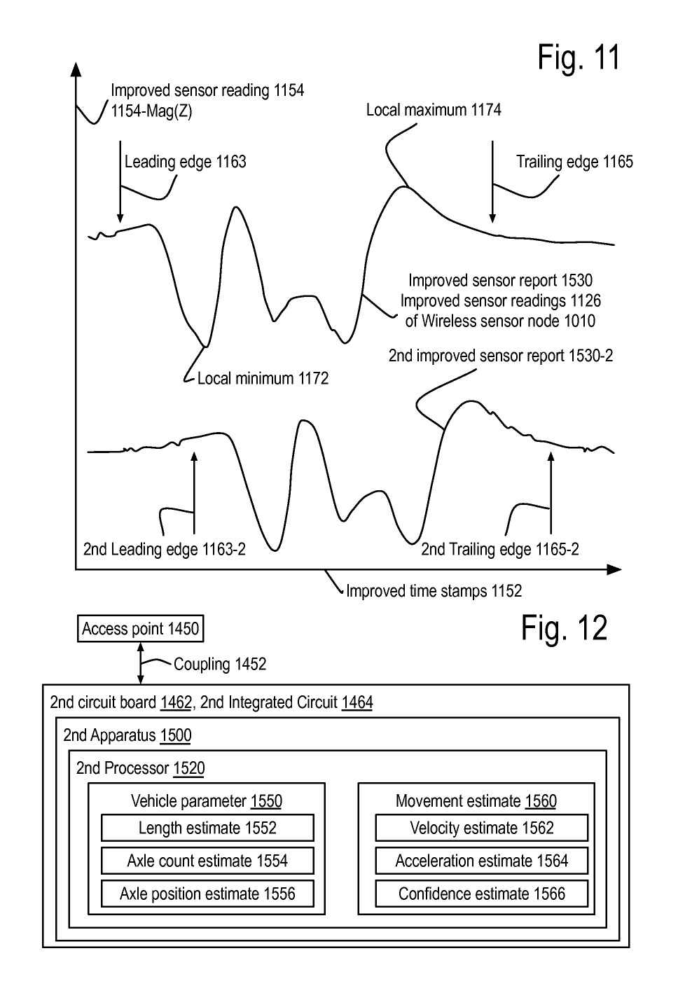

FIG. 11 shows a graph of an example of the improved sensor report 1530 and the second improved sensor report 1530-2 as received by the access point 1450 and used by the second processor 1520.
The first improved sensor report 1530 may be received from first wireless sensor node 1020 and the second improved sensor report 1530-2 may be received from the second first wireless sensor node 1020-2.
The horizontal axis represents improved time stamps 1152 and the vertical axis, represents the improved sensor readings 1154, in particular, the Z axis improved reading 1154-mag(Z).
Note that in some embodiments, the improved sensor report 1530 may include the leading edge 1163 and/or the trailing edge 165. Similarly, the second improved sensor report 1530-2 may include a second leading edge 1163-2 and/or a second trailing edge 1165-2.
In some embodiments, the local minimum 1172 and/or the local maximum 1174 may be included in the improved sensor report 1530 or derived from the improved sensor report 1530.

Returning to the second apparatus 1450 shown in FIG. 1. The second apparatus 1500 may be configured to receive the improved sensor report 1520 from each of at least two of the first wireless sensor nodes such as 1020 and 1020-2 to create a table of the improved reading characteristics 1156 for the first wireless sensor node 1020 in response to the presence of a vehicle 1006 near the first wireless sensor node 1020.

The second apparatus 1500 may include a second processor 520 configured to generate a vehicle parameter 1550, a movement estimate 1560 and/or a traffic ticket message 1570 about a vehicle 1006 passing near and/or between the first wireless sensor node(s) 1020 and 1020-2 as shown in FIG. 1. A second circuit board 1462 and/or a second integrated circuit 1464 may include the second apparatus 1500.

FIG. 12 shows an alternative example where the second apparatus 1500 may not be included in the access point 1450 but may be included in embodiments of the second circuit board 1462 and/or the second integrated circuit 1464. The second processor 1520 may be configured to communicate via the coupling 1452 with the access point 1450 to receive the improved sensor reports 1530 and 1530-2.

The access point 1450 may be coupled 1452 to the second apparatus 1500, possibly via at least one wireline and/or wireless communications coupling. The wireline communications coupling may be compatible with a version of, but not limited to, a LAN coupling, a Universal Serial Bus (USB) coupling and/or a Firewire IEEE 1394 coupling. The wireless communications coupling may employ any version of IEEE 802 communications protocols, for example, the IEEE 802.15.4 protocol 1222 and/or the IEEE 802.11 protocol 1224, and/or any version of Bluetooth protocol 1226 and/or any version of the low power Bluetooth protocol 1228.

The vehicle parameters 1550 of the vehicle 1006 may include the estimated length 1552, an axle count 1554 and/or at least one axle position estimate 1556. The movement estimate 1560 of the vehicle 1006 may be based upon response to the tables of the reading characteristics 1156 and may include a velocity estimate 1562 and/or an acceleration estimate 1564 and may further include a confidence estimate 1566 of one or both of the velocity estimate and the acceleration estimate. The traffic ticket message 1570 of FIG. 1 may based upon response to the movement estimate 1560.

The second processor 1520 may further generate a correlation of the extrema estimates of FIG. 10C from the two improved sensor reports 1530 and 1530-2 by matching local minima 1172 and local maxima 1174 between the tables to create at least two correlated extrema. Alternatively, the second processor 1520 may generate a correlation between the edge estimates, in particular, between the leading edge 1163 and the trailing edge 1165. The movement estimate may be further based upon a difference in the improved time stamps 1152 of the correlations.

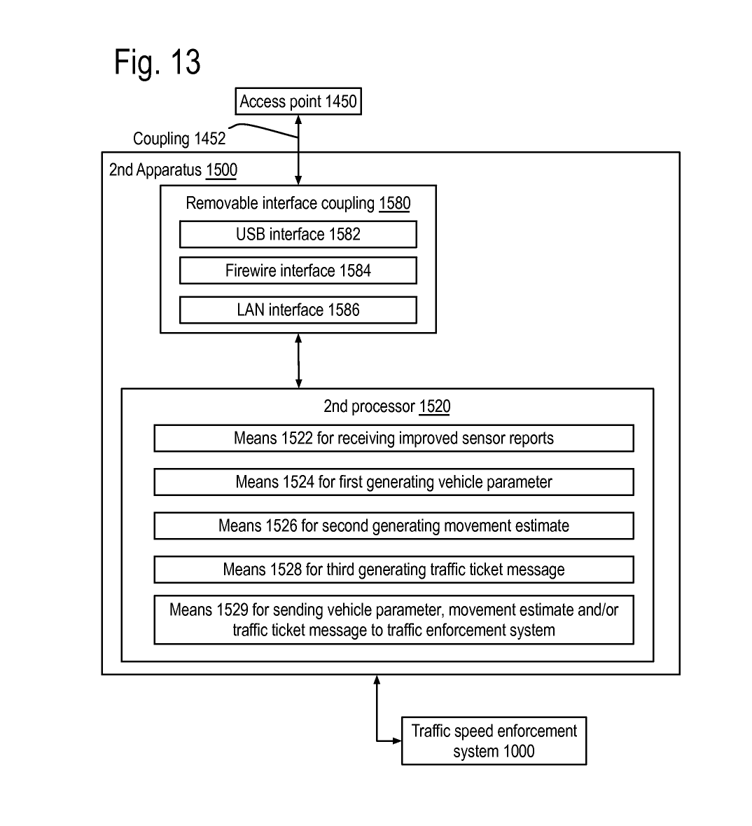

FIG. 13 shows the second apparatus 1500 may further include a removable interface coupling 1580 to the second processor 1520. The second processor may be further configured to use the removable interface coupling 1580 to receive the improved sensor reports such as 1530 and 1530-2. The second processor 1520 may send the vehicle parameter 1550 and/or the movement estimate 1560 and/or the traffic ticket message 1570 either through the removable interface coupling to the access point or directed to other systems such as the traffic speed enforcement system 1000. Examples of the removable interface coupling 1580 include but are not limited to various forms of any of the following Universal Serial Bus 1582, Firewire (IEEE 1394) 1584, and LAN interfaces 1586 such as interfaces to Ethernet and Power Over Ethernet (POE).

The second processor 1520 may include at least one of the following:
A means 1522 for receiving the improved sensor report 1520 from each of at least two of the first wireless sensor nodes 1020 and 1020-2 to create the table of the reading characteristics 1156 for the first wireless sensor node.
A means 1524 for first generating the vehicle parameter 1550 of the vehicle 1006.
A means 1526 for second generating the movement estimate 1560 of the vehicle passing between the first wireless sensor nodes 1020 and 1020-2.
A means 1528 for third generating the traffic ticket message 1570 based upon the movement estimate 1560.
And a means 1529 for sending at least one of the vehicle parameter 1550, the movement estimate 1560, and/or the traffic ticket message 1570 to the traffic speed enforcement system 1000.

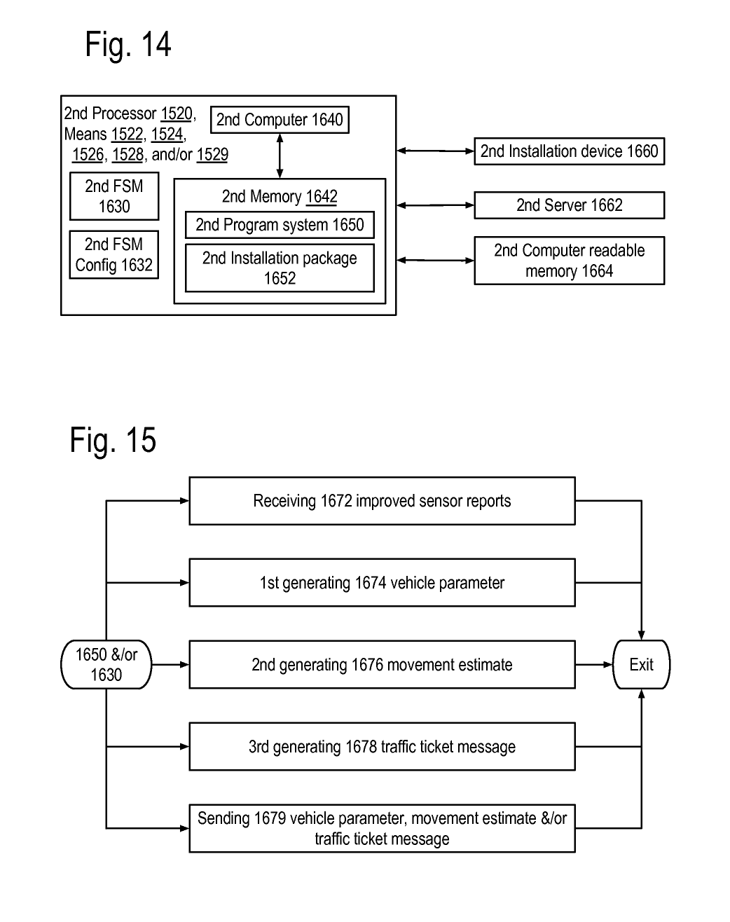

FIG. 14 shows at least one member of a means group that may include at least one implementation of at least one of a second finite state machine 1630, a second computer 1640 and a second accessible memory 1642 including a second program system 1650 configured to instruct the second computer 1640. The means group consists of the second processor 1520, the means 1522 for receiving, the means 1524 for first generating, the means 1526 for second generating, the means 1528 for third generating, and the means 1529 for sending.

As before, the second FSM 1630 may be configured to receive at least one input, maintain at least one state and generate at least one output in response to a value of at least one of the inputs and/or in response to the value of at least one of the states. The FSM configuration 1632 may be used to configure the FSM 1630 implemented by a programmable logic device, such as a Field Programmable Gate Array (FPGA).

The second computer 1640 may include at least one instruction processor and at least one data processor with at least one of the instruction processor instructed by at least one of the instruction processors in response to the program system 1650, possibly through accesses of the second memory 1642 by the second computer 1640.

The second installation package 1652 may be configured to instruct the second computer 1640 to install the second program system 1650 and/or may be configured to instruct the second computer and/or the second FSM 1630 to install the second FSM configuration 1632.

As used herein, the second memory 1642 and/or the second computer readable memory 1664 may include at least one instance of a volatile and/or a non-volatile memory component. A volatile memory component tends to lose its memory contents without a regular supply of power, whereas a non-volatile memory component tends to retain its memory contents without needing such a regular supply of power.

The second computer readable memory 1664 and/or the second server 1662 and/or the second installation device 1660 may include various communications interfaces to deliver the second program system 1650, the second installation package 1652, and/or the second FSM configuration 1632: a Bluetooth interface, and/or a Wireless LAN (WLAN) interface, and/or some combination of these and possibly other interfaces.

FIG. 15 shows the second program system 1650 includes, and/or the second FSM 1630 is configured to support, at least part of at least one of the steps of
Receiving 1672 the improved sensor report 1530 from each of at least two of the first wireless sensor nodes 1020 and 1020-2 to create the table of the reading characteristics 1156.
First generating 1674 the vehicle parameter 1550 of the vehicle 1006 in response to the table of the improved reading characteristics 1156 for at least one of the first wireless sensor nodes 1020 and/or 1020-2.
Second generating 1676 the movement estimate 1560 of the vehicle 1006 passing near and/or between the first wireless sensor nodes 1020 and 1020-2 in response to the tables of the improved reading characteristics 1156.
Third generating 1678 the traffic ticket message 1570 based upon the movement estimate 1560.
And sending 1679 the vehicle parameter, the movement estimate and/or the traffic ticket message 1570 to the traffic speed enforcement system 1000.

FIG. 16 shows a second set of embodiments as a third apparatus 800 including a third processor 1820 that may be included in a third circuit board 1472 and/or a third integrated circuit 1474 and/or an access point 1450 configured to communicate with first wireless sensor nodes 1008 and 1008-2 that do not emulate increasing the sampling frequency of their sensors 1012 and 1012-2. The third apparatus 1800 and/or the third processor 1820 provide the wireless sensor network 1002 an emulation of increased sampling frequency.
The third processor 1820 may be configured to respond to sensor reports 1023 and 1023-2 received from at least two of the first wireless sensor nodes 1008 and 1008-2 by creating at least one table of sensor reading estimates 1024 for each of the first wireless sensor nodes 1008 and 1008-2 emulating sensor readings 1020 and 1020-2 being generated by the first wireless sensor nodes 1012 and 1012-2. The sensor readings are being generated N1 times per time unit, with the N1 being at least two.
The first wireless sensor node 1008 generates a sensor report 1023 based upon the sensor readings 1020 generated by the sensor 1012. The first wireless sensor node 1008 wirelessly communicates 1022 with the access point 1450 to deliver the first sensor report 1023 for use by the third processor 1820. The third processor 1820 responds to the first sensor report 1023 by generating at least one first sensor reading estimate 1024.
The second first wireless sensor node 1008-2 generates a second sensor report 1023-2 based upon the second sensor readings 1020-2 generated by the second sensor 1012-2. The second first wireless sensor node 1008-2 wirelessly communicates 1022 with the access point 1450 to deliver the second sensor report 1023-2 for use by the third processor 1820. The third processor 1820 responds to the second sensor report 1023-2 by generating at least one second sensor reading estimate 1024-2.
Please note, since the vehicle parameter 1550 include the vehicle length estimate 1552, in some embodiments of the third apparatus 1800 may operate on just one sensor report 1023 and just one sensor reading estimate 1024. To simplify this discussion, only the sensor reading estimates 1024 and not 1024-2 will be discussed in what follows to simplify and clarify the disclosure. While this is being done to aid the clarity of the disclosure and expedite patent prosecution, it is not intended to limit the scope of the claims in any way.
Also, use of language such as the table of sensor reading estimates is meant to clarify the discussion and does not limit the implementation of the stored states of any of the apparatus 1100, 1500 and/or 1800.
And the third processor 1820 may respond to the table of the sensor reading estimates 1024 to generate at least one improved estimate 1150 and/or an improved time stamp 1152 emulating the sensor readings 1020 received at least twice the N1 times per time unit.

The sensor readings 1020 and/or 1020-2 may be distributed evenly or unevenly throughout the time unit as previously discussed in FIGS. 2A and 2B. The first wireless sensor nodes 1020 may be configured to use sensors 1012 as previously discussed.

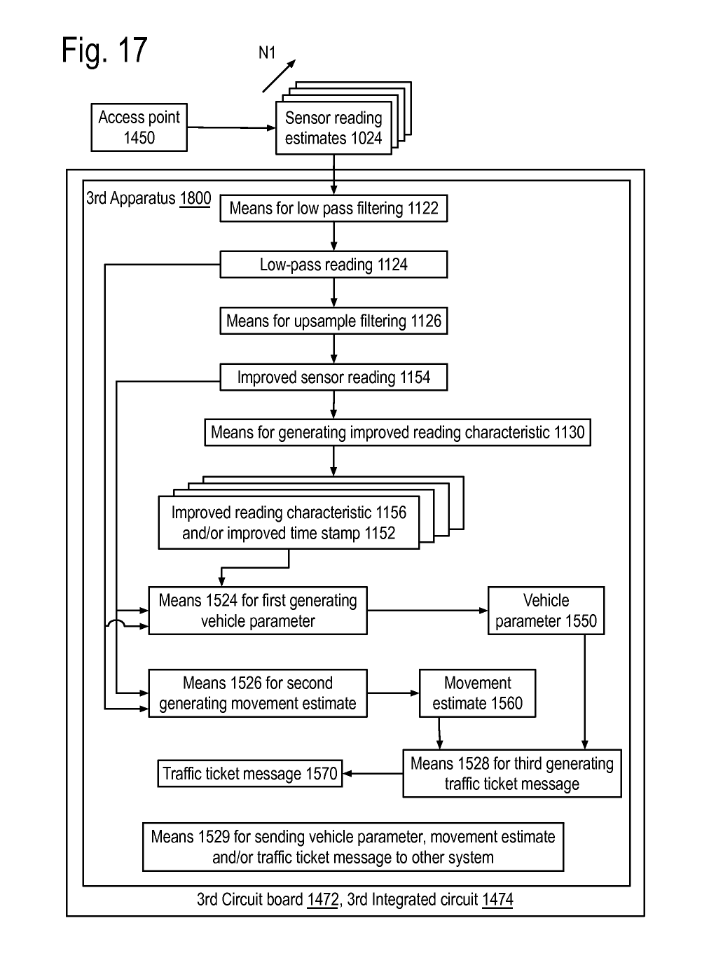

FIG. 17 shows another embodiment of the third apparatus 1800 that is not included in the access point 1450 but may be included in the third circuit board 1472 and/or the third integrated circuit 1474. Some details of the third processor 1820 are shown indicating means for filtering sensor reading estimates 1024, which are similar to the previous discussion of components with the same reference numbers.

In some embodiments a single integrated circuit may have configurations as the second integrated circuit 1464 and as the third integrated circuit 1474.

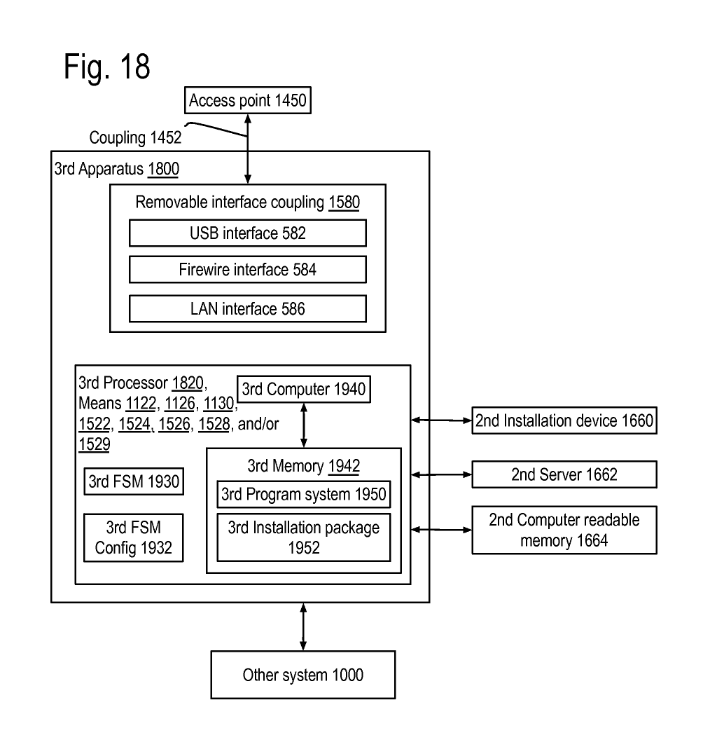

FIG. 18 shows the third apparatus 1800 including a removable interface coupling 1580 and the third processor 1820 and/or at least one of its means including at least one instance of a third finite state machine 1930 and/or a third computer 1940 and/or a third accessible memory 1942 possibly containing a third program system 1950 and/or a third installation package 1952. This set of embodiments may include the second installation device 1660 and/or the second server 1662 and/or a second computer readable memory 1664 as previously discussed with regards the second apparatus 1500.

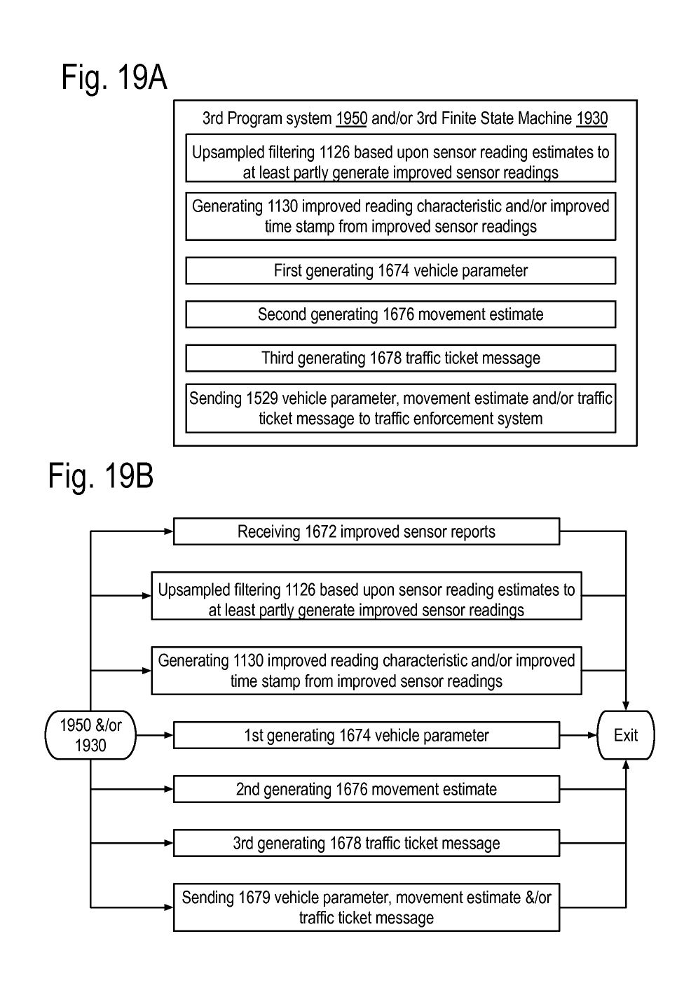

FIGS. 19A and 19B show some details of the third program system 950 and/or the operations of the third finite state machine 1932 which are similar to a merger of the operations of the first processor 1120 and second processor 1520 with the main difference being that the third processor 1820 starts with sensor reading estimates 1024 and the first processor 1120 starts with the sensor readings 1020. Since like reference numbered components operate similarly to the previously discussed components with the same reference numbers, their discussion will not be repeated here.

Regarding the Second Aspect:

This disclosure relates to second systems that use a wireless sensor network including vibration sensor nodes embedded in pavement. The invention also relates to second systems that use vibration readings to generate vehicle parameters such as vehicle length, the number, positions and/or spacing of some or all of the axles of the vehicle, which may be used to generate a vehicle classification. The second system may also monitor the weight of vehicles passing over or near them on a lane to assess the pavement damage of the lane.

This invention relates to wireless weigh-in-motion or W-WIM second systems and their components, in particular, to wireless sensor nodes configured to operate one or more vibration sensors, access points configured to wirelessly communicate with the one or more wireless sensor nodes, and processors configured to use vibration readings of the wireless sensor nodes to generate the vehicle parameters and/or the vehicle classification and/or an estimated weight of the vehicle and/or the deflection of the pavement caused by the passage of the vehicle.

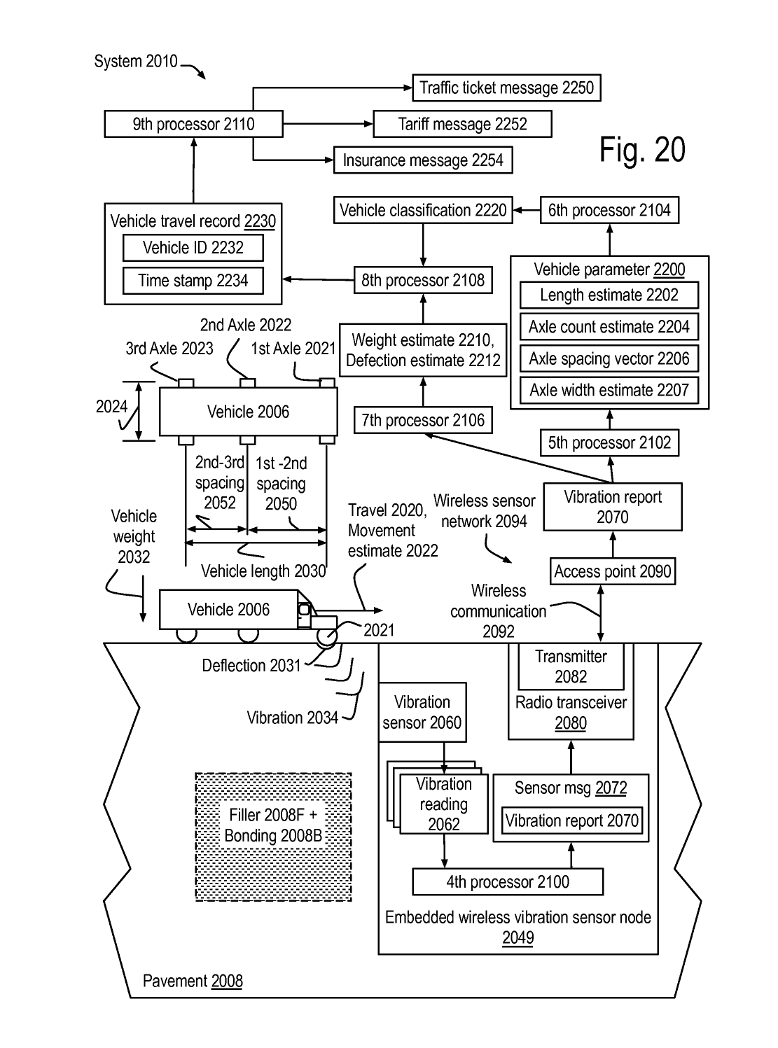

Referring more specifically to the Figures, FIG. 20 shows an example second system 10 that may include at least one wireless sensor network 2094. The wireless sensor network 2094 may include at least one access point 2090 configured to wirelessly communicate 2092 with at least one embedded wireless vibration sensor node 2049 embedded in pavement 2008 with a vehicle 2006 traveling 2020 on the pavement inducing vibrations 2034 in the pavement due to the deflection 2031 of the pavement. An access point 2090 receives a vibration report 2070 via wireless communication 2092 from the wireless vibration sensor node 2049 in response to the vibrations 2034 of the vehicle 2006 traveling 2020 on the pavement 2008.

The pavement 2008 may include a filler 2008F and a bonding agent 2008B. The filler 2008F may include sand, gravel and/or pumice. The bonding agent 2008B may include asphalt and/or cement.

The embedded wireless vibration sensor node 2049 may include at least one vibration sensor 2060 and at least a radio transmitter 2082 and often a radio transceiver 2080 as shown. The embedded wireless vibration sensor node 2049 may be configured to operate as follows: The vibration sensor 2060 may respond to the vibrations 2034 by generating at least one vibration reading 2062. The vibration report 2070 may be generated based upon at least one and often many vibration readings 2062. The radio transmitter 2082 may be configured to send the vibration report 2062.

The second system 2010 may use the vibration report 2070 to generate at least one vehicle parameter 2200 of the vehicle 2006. The vehicle parameter 2200 may include a length estimate 2202, an axle count estimate 2204, an axle spacing vector 2206, and/or an axle width estimate 2207. In certain implementations, the vehicle parameter 2200 may include each of these components.

For the sake of simplifying the discussion, most of this document will focus on the vehicle parameter 2200 including each of the components 2202, 2204, 2206 and 2207. This should not be interpreted as intending to limit the scope of the claims. By way of example, consider the following interpretation of the vehicle parameter 2200 for the vehicle 2006 shown in FIG. 20.
The length estimate 2202 may approximate the vehicle length 2030.
The axle count estimate 2204 may be three, representing the count of the first axle 2021, the second axle 2022 and the third axle 2023.
The axle spacing vector 2206 may have more than one coordinate components. For example, for a vehicle 6 including three axles 2021, 2022 and 2023, the axle spacing vector 2206 may approximate a first to second axle spacing 2050, the second to third axle spacing 2052. The first to second spacing 2050 may approximate the spacing between the first axle 2021 and the second axle 2022. The second to third spacing 2052 may approximate the spacing between the second axle 2022 and the third axle 2023. Note that the order of these components may differ from one implementation to another, and that the units may vary, from meters, to centimeters, to feet, and/or to inches in some implementations.
The wheel base estimate 2207 may approximate the axle width 2024 of the vehicle 006. The units may vary, from meters, to centimeters, to feet, and/or to inches in some implementations. Alternatively, the wheel base estimate 2207 may indicate one of several ranges, for instance, less than six feet, between six feet and ten feet, between 10 and 15 feet, between 15 feet and twenty feet and/or greater than twenty feet.
The wheel base estimate 2207 may be specifically used when the axle count estimate 2204 indicates a vehicle with two axles to classify motor cycles, pickups, trucks and busses. In some implementations, the wheel base estimate 2207 may only be occur in the vehicle parameters 2200 when the axle count estimate 2204 indicates two axles.
The generation of the vehicle parameters 2200 will be further discussed later.

The vehicle parameters 2200, in some situations, the length estimate 2202, the axle count estimate 2204, the axle spacing vector 2206 and the wheel base estimate 2207 may be used to generate a vehicle classification 2220 for the vehicle 2006. In this example, the vehicle classification may indicate a vehicle capable of carrying a standard size container of roughly 40 feet (thirteen meters) in length.

The second system 2010 may use the vibration report 2070 to generate a weight estimate 2210 of the vehicle 2006 and/or to generate a deflection estimate 2212 of the pavement 2008 in response to the travel 2020 of the vehicle 6 over the pavement.
The weight estimate 2210 may be in terms of different units in different implementations, for instance, units of pounds, tons, kilograms and/or metric tons are four reasonable choices that may be found in various implementations of the second system 2010 somewhere on the planet.
Similarly, the deflection estimate 2212 may be may be in terms of different units in different implementations.
In some implementations, a movement estimate 2022 and/or the vehicle parameters 2200, 2202, 2204, 2206 and/or 2207 may be used to further support generating the weight estimate 2210.
The generation of the weight estimate 2210 and/or the deflection estimate 2212 will be discussed in detail later.
The movement estimate 2022 may indicate at least a velocity of the vehicle 2006 and preferably also indicating its acceleration. Alternatively, the movement estimate 2022 may be in terms of time to travel 2020 between two of the embedded wireless vibration sensor nodes 2049.

The vehicle identification 2232 for the vehicle 2006 may be used with the vehicle classification 2220 and the weight estimate 2210, as well as possibly the vehicle parameters 2200-2206 and the movement estimate 2022 to generate a vehicle travel record 2230. In some implementations, the vehicle travel record 2230 may also include the vehicle classification 2220, the weight estimate 2210, the vehicle parameters 2200-2207 and/or the movement estimate 2022, as well as possibly a time stamp 2234. In some implementations, the vehicle travel record 2230 may include a compression of some or all of these components. For instance, if the vehicle identification 2232 is an image of a license plate of the vehicle 2006, it may be a compressed image using some compression technology such as JPEG.

The second system 2010 may use the vehicle travel record 2230 to generate at least one of a traffic ticket message 2250, a tariff message 2252 and/or an insurance message 2254, each for the vehicle 2006. Consider the following examples of these generated products of the process of operating the second system:
These messages 2250, 2252 and 2254 may include much the same information, but may differ in terms of when they are generated and whom they are sent to.
For example, the traffic ticket message 2250 may indicate that the vehicle 2006 with three axles 2021, 2022, and 2023 with the approximate vehicle length 2030 of 55 feet and carrying a vehicle weight 2032 of approximately 120 tons has a movement estimate 2022 of about 80 miles per hour with a confidence interval within 2 miles per hour. The vehicle 2006 may be identified 2232 by an image of its license plate and/or a Radio Frequency IDentification (RF-ID) tag.
The traffic ticket message 2250 may only be generated when the vehicle 2006 is breaking a traffic regulation. The tariff message 2252 may be sent for all vehicles 2006 in certain vehicle classifications 2220. The insurance message 2254 may only be generated for vehicles 2006 whose vehicle identifications 2232 indicate that an insurance company has agreed to pay for the insurance message about the vehicle 2006.

Several processors 2100, 2102, 2104, 2106, 2108, and/or 2110 may be involved in the data processing regarding these vibration reports 2070 in various implementations of the second system 2010.
A fourth processor 2100 may be configured to respond to the vibration readings 62 to generate the vibration report 2070.
A fifth processor 2102 may be configured to respond to the vibration report 2070 to generate at least part of the vehicle parameter 2200 of the vehicle 2006.
A sixth processor 2104 may be configured to respond to the vehicle parameter 2200 of the vehicle 2006 to generate the vehicle classification 2220.
A seventh processor 2106 may be configured to respond to the vibration report 2070 to generate the weight estimate 2210 of the vehicle weight 2032 and/or the deflection estimate 2212 of the deflection 2031 of the pavement 2008 from the vehicle 2006 traveling 2020 over the pavement.
A eighth processor 2108 may be configured to respond to the vehicle classification 2220, the weight estimate 2210, the vehicle identification 2232 and the vehicle movement estimate 2022 to generate the vehicle travel record 2230 for the vehicle 2006.
And a ninth processor 2110 may be configured to respond to the vehicle travel record 2230 to generate at least one of the traffic ticket message 2250, the tariff message 2252 and the insurance message 2254.

The wireless sensor network 2094, the transmitter 2082 and/or the transceiver 2080 at the wireless sensor nodes 2049 may be configured to operate in accord with a wireless communication 2092 protocol, such as at least one version of an Institute for Electrical and Electronic Engineering (IEEE) 802.15.4 protocol, an IEEE 802.11 protocol, a Bluetooth protocol and/or a Bluetooth low power protocol.

The wireless sensor network 2094 may use wireless communications 2092 employing a modulation-demodulation scheme, that may include any combination of a frequency division multiple access scheme, a Time Division Multiple Access (TDMA) scheme, a Code Division Multiple Access (CDMA) scheme, a frequency hopping scheme, a time hopping scheme, and/or an Orthogonal Frequency Division Multiplexing (OFDM) scheme.

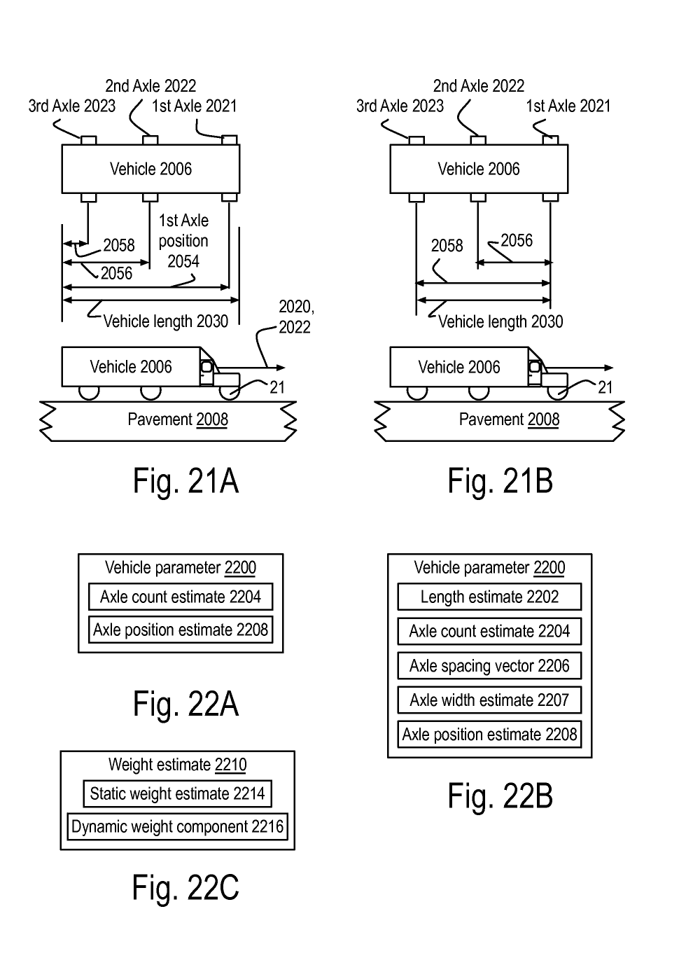

FIGS. 21A and 21B show examples of how the vehicle parameters 200 may be alternatively defined by different implementations of the second system and its components of FIG. 20.
FIG. 21A shows the vehicle length 2030 defined and measured as the distance between the front and the back of the vehicle 2006. The first axle 2021 is shown with a first axle position 2054 as measured from the back of the vehicle 2006. The second axle 2022 is shown with a second axle position 2056 measured again from the back of the vehicle 2006. And the third axle 2023 is shown with a third axle position 58 also measured from the back of the vehicle 2006.
FIG. 21B shows the vehicle length 2030 defined and measured as the distance between the first axle 2021 and the last, in this case, the third axle 2023. The axle positions are measured in this example from the first axle, so the first axle position 2054 is always zero, and may not be reported. The second axle position 2056 is the spacing between the first axle 2021 and the second axle 2022. The third axle position 2058 is the distance from the first axle 2021 to the third axle 2023, which may be seen as the sum of the first to second spacing 2050 and the second to third spacing 2052 of FIG. 20.

FIGS. 22A and 22B show examples of how the second system 2010 and its processors 2100, 2102, 2104, 2106, 2108, and/or 2110 of FIG. 20 may implement and/or use the vehicle parameter 2200.
As used herein, the axle count estimate 2204 may represent the number of axles as essentially an integer, possibly with a designator for a fifth wheel that may not be considered as a full axle.
FIG. 22A shows an example of the vehicle parameters 2200 including an axle count estimate 2204 and an axle position estimate vector 2208, which could be based upon the definitions and measurements shown in FIG. 21A and/or FIG. 21B.
FIG. 22B shows another example of the vehicle parameters 2200 including the length estimate 2202, the axle count estimate 2204, the axle spacing vector 2206 and/or the axle position estimate vector 2208.
The length estimate 2202 may be based upon the definitions and measurements of the vehicle length 2030 as shown in FIGS. 20 and 21B or in FIG. 21A.
The axle spacing vector 2206 may represent the spacing between at least some of the adjacent axles. FIG. 20 shows the first to second spacing 2050 as the distance between the first axle 2021 and the second axle 2022. The second to third spacing 2052 as the distance between the second axle 2022 and the third axle 2023.
Note that in some implementations, vehicle classification may not require knowing all the spacing estimates between axles. By way of example, in the United States, when the axle count estimate 2204 has a value of 5, the spacing between the third axle and the fourth axle is not used in classifying the vehicle 2006, and may not be generated.
The axle position estimate 2208 may be based upon the definitions and measurements shown in FIG. 21A and/or FIG. 21B.

FIG. 22C shows some details of certain implementations of the weight estimate 2210, which may contain a static weight estimate 2214 and a dynamic weight component 2216. The static weight estimate 2214 may refer to the weight of the vehicle 2006, possibly as measured for a specific axle, such as the first axle 2021. The dynamic weight component 2216 may refer to the force induced by the vehicle 2006, possibly from the oscillation or vibration of the axles and/or the chassis of the vehicle.

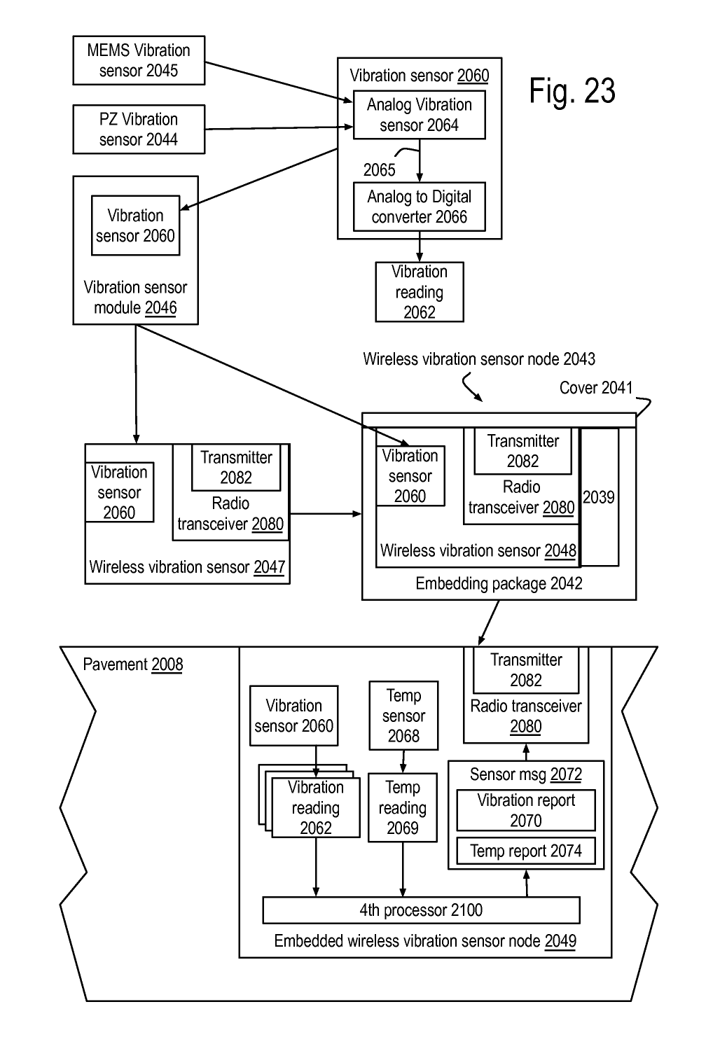

While there is more to discuss about how the second system 2010 operates, FIG. 23 will discuss how the embedded wireless vibration sensor node 2049 is created in the pavement 2008.

FIG. 23 shows some example implementations of components that may be used and/or included in the embedded wireless vibration sensor node 2049 embedded in the pavement 2008 shown in FIG. 20.

The vibration sensor 2060 may include an analog vibration sensor 2064 configured to generate an analog vibration signal 2065 presented to an analog to digital converter 2066 that may generate the vibration reading 2062 in response to the stimulus provided by the analog vibration signal.
In some embodiments the vibration reading 2062 may represent a number, which may typically be in a fixed point format or a floating point numeric format.
The vibration sensor 2060 may in some situations further include an amplifier to further stimulate the analog to digital converter 2066.
The analog vibration sensor 2064 may be implemented with a MEMS vibration sensor 2045, which has also been called a MEMS accelerometer in the cited provisional patent application. As used herein, MEMS stands for Micro-Electro-Mechanical Second systems.
In some embodiments, the analog vibration sensor 2064 may be implemented by at least one Piezoelectric (PZ) vibration sensor 2044.

Among the other components that may be included or used to create the embedded wireless vibration sensor node 2049, are a vibration sensor module 2046, a wireless vibration sensor 2047 and/or a wireless sensor node 2043.
The vibration sensor module 2046 may include at least one of the vibration sensors 2060 possibly coupled to a printed circuit board or insertion package configured for installation into the wireless vibration sensor 2048 and/or the wireless vibration sensor node 2043.
The wireless vibration sensor 2047 may include the vibration sensor 2060 and a radio transmitter 2082 and/or a transceiver 2080 configured to send the vibration report 70 based upon the vibration reading 2062.

The wireless vibration sensor node 2043 may be configured to be embedded in the pavement 2008 and may include the vibration sensor 2060 and the radio transmitter 2082 and/or transceiver 2080.
The wireless vibration sensor node 2043 may further include the vibration sensor 2060 communicatively coupled to send the vibration readings 2062 to the fourth processor 2100, which in turn may communicate the vibration report 2070 to the radio transmitter 2082 and/or the transceiver 2080.
While not shown in the Figures, the wireless vibration sensor node 2043 may further include a power controller that may use a battery to power the other active components. A photocell and/or strain gauge may be used to recharge the battery.
In some implementations, at least one of the embedded wireless vibration sensors 2047, the wireless vibration sensor node 2043 and/or the embedded wireless vibration sensor node 2049 may include a temperature sensor 2068 configured to generate a temperature reading 2069. The fourth processor 2100 may be further configured to generate and send a temperature report 2074, possibly as part of a sensor message 2072. More than one of the sensor messages 2072 may be used to send the vibration report 2070 and/or the temperature report 2074.
In some embodiments, the analog to digital converter 2066 may be included in the fourth processor 2100, or alternatively, be a separate component. The analog to digital converter 2066 may be used to generate both the vibration reading 2062 and the temperature reading 2069.
These components may be enclosed in an embedding package 2042 by a cover 2041. The embedding package 2042 may be filled with a packing material to minimize mechanical shock. The cover 2041 may be screwed down onto the embedding package, possibly with a strip of elastomer sealant or glue to further bind the cover 2041 to the embedding package 2042. The embedding package 2042 may approximate a cube about 3 inches on a side in some implementations.
The wireless vibration sensor node 2043 may include a means for suppressing 2039 acoustic noise affecting the vibration sensor 2060 from the engines of the vehicles 2006 passing the embedded wireless sensor node 2049. The means for suppressing may include the segment of pavement in which the wireless sensor node 2043 is embedded, the fused silica packing in the wireless sensor node and/or an air-tight seal between the embedding package 2042 and the cover 2041.

As used herein, providing a component to create something refers to placing that component in position and then creating that something. This may use an automated or human parts assembly process. The assembly process(es) may bond together components using glues, solders, resins, nuts, bolts and/or press fits.
The MEMS vibration sensor 2045 and/or the Piezoelectric vibration sensor 2044 may be provided to create the vibration sensor 2060.
The vibration sensor 2060 may be provided to create the vibration sensor module 2046, the wireless vibration sensor 2047, the wireless vibration sensor node 2043 and/or the embedded wireless vibrations sensor node 2049.
The vibration sensor module 2046 may be provided to create the wireless vibration sensor 2047, the wireless vibration sensor node 2043 and/or the embedded wireless vibrations sensor node 2049.
The wireless vibration sensor 2047 may be provided to create the wireless vibration sensor node 2043 and/or the embedded wireless vibrations sensor node 2049.
And the wireless vibration sensor node 2043 may be provided into a cavity in the pavement 2008 to create the embedded wireless vibrations sensor node 2049. The wireless vibration sensor node 2043 may be placed into a four inch hole drilled into the pavement 2008 that is then filled with epoxy to create the embedded wireless vibrations sensor node 2049. Installation of the embedded wireless vibration sensor node may take under ten minutes.

In some implementations, the embedded wireless vibration sensor node may implement some of the processors.

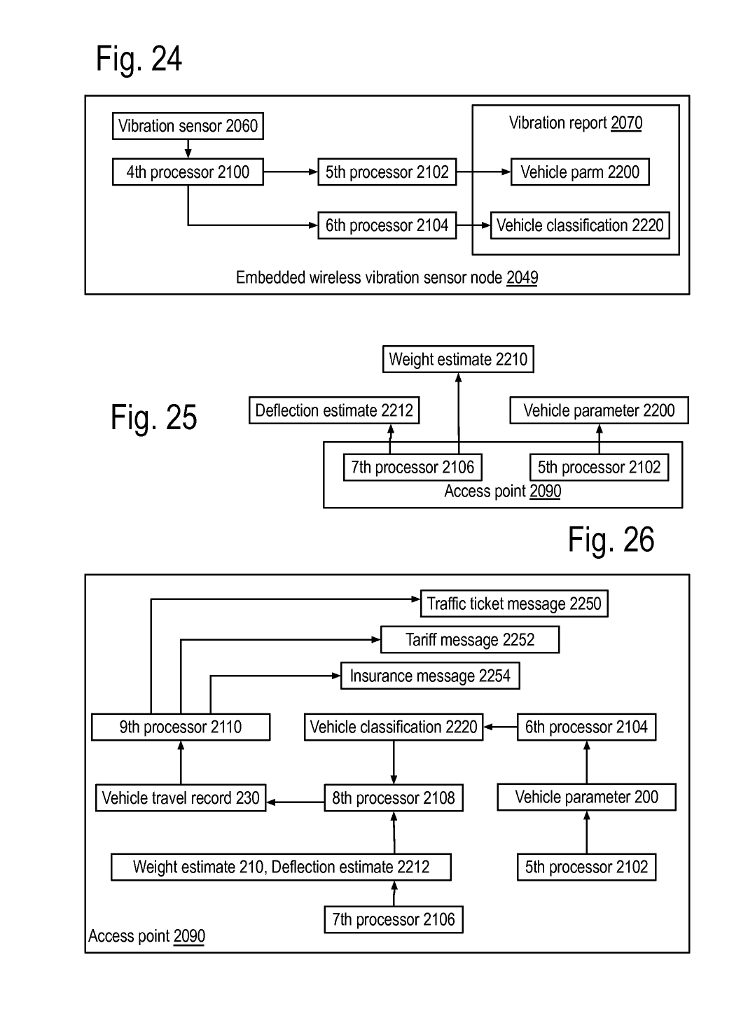

FIG. 24 shows an example of the embedded wireless vibration sensor node 2049 further including the fifth processor 2102 and the sixth processor 2104, with the vibration report 2070 further indicating the vehicle parameter 2200 and the vehicle classification 2220.

FIGS. 25 and 26 show examples of various combinations of the second through the ninth processor 2102 to 2110 may be implemented in the access point 2090.
FIG. 25 shows the access point 2090 may include the fifth processor 2102 and the seventh processor 2106.
FIG. 26 shows the access point 2090 may further include the sixth processor 2104, the eighth processor 2108 and the ninth processor 2110.

The wireless sensor network 2094 may also include wireless sensor nodes 2096 operating a magnetic sensor 2097, an optical sensor, a digital camera, and/or a radar.

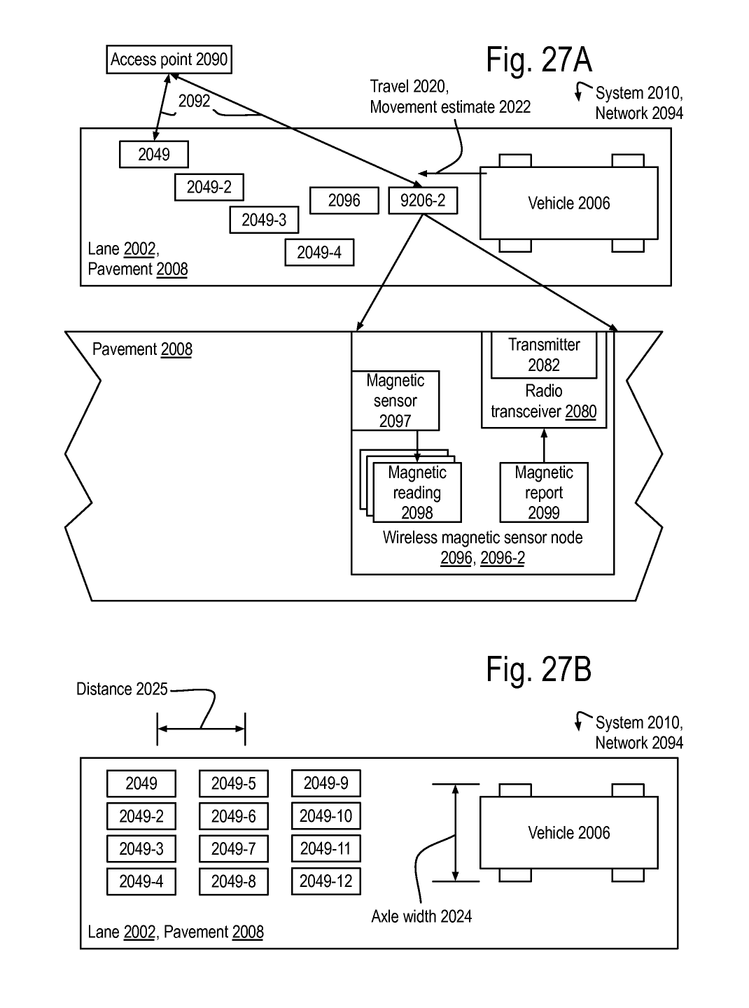

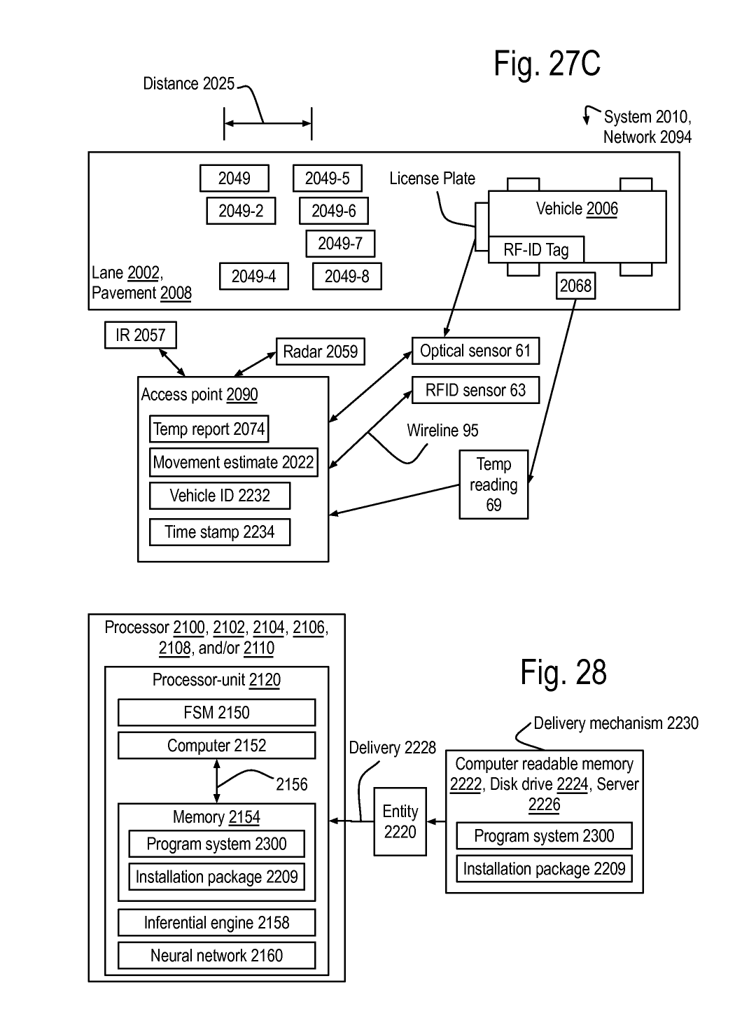

FIGS. 27A to 27C show examples of some of the details of the second system 2010 of FIG. 20.

FIG. 27A shows an example of the second system 2010 of FIG. 20 further including more than one, in this case four instances of the embedded wireless vibration sensor nodes 2049 to 2049-4 embedded in the pavement 2008 of a lane 2002 of a roadway. The second system 2010 may further include one or more, in this case two instances, of a wireless magnetic sensor node 2096 and 2096-2 embedded in the pavement 2008 of the lane 2002. The second system 2010 may be configured to use the wireless magnetic sensor nodes 2096 and 2096-2 to generate the movement estimate 2022 of the vehicle 2006 traveling 2020 in the lane 2002. In some embodiments, the wireless magnetic sensor nodes 2096 and 2096-2 may be used to generate and/or refine the length estimate 2202.

The wireless magnetic sensor node 2096 may include a magnetic sensor 2097 configured to generate magnetic readings 2098 as the vehicle 2006 travels 2020 close to the node 2096. These magnetic readings 2098 may be used to generate a magnetic report 2099 that may be sent by the transmitter 2082 to the access point 2090 for use in generating the movement estimate 2022 and/or the length estimate 2202.

FIG. 27B shows another example of the second system of FIGS. 20 and 27A that may also determine the axle width 2024 for a vehicle 2006 with two axles. This example of the second system 2010 includes three columns of the wireless vibration sensor nodes configured with a distance 2025 between the columns. The first column may include the wireless vibrations sensor nodes 2049 to 2049-4. The second column may include the wireless vibration sensor nodes 2049-5 to 2049-8. The third column may include the wireless vibration sensor nodes 2049-9 to 2049-12.

The distance 2025 may be measured in different fashions, such as from one edge as shown in FIG. 27B, or from the centers as shown in FIG. 27C.

The columns may have the same number of wireless vibration sensor nodes 2049 as shown in FIG. 27B or may have different numbers of wireless vibration sensor nodes as shown in FIG. 27C.

In some embodiments, more than two columns may be useful in seventh processing 2106 the vibration readings 2062 and/or the vibration reports 2070 to generate the weight estimate 2210. Consider the following example implementations:
The static weight estimate 2214 may be generated by removing the dynamic weight component 2216 from the weight estimate 2210. This removal may be performed by averaging the weight estimates based upon each of the columns of embedded wireless vibration sensor nodes 2049 and so on. Other signal processing steps may be used to remove the dynamic weight component 2216 from the weight estimate 2210. This may be preferred when the distance 2025 between the columns is at least about twelve feet or at least about four meters. Such implementations of the second system 2010 may use the weight estimate 2210 as the static weight estimate 2214 after the dynamic weight component 2216 has been removed.
The dynamic weight component 2216 may be recognized in the weight estimate 2210 thereby revealing the static weight estimate 2214, which may be calculated later. The second system 2010 may be implemented to use the weight estimate 2210 with the recognized dynamic weight component 2216.
Note that in some implementations of the second system 2010, combinations of these last two examples may be found.

FIG. 27C shows another example of the second system 2010 of FIGS. 20 and 27A that may further include a radar 2059, an infrared sensor 2057 and/or optical sensors 2061. The second system 2010 may also include a temperature sensor 2068 that may not be implemented in the embedded wireless vibration sensor nodes 2049. The distance 2025 may be measured from the centers. The columns may have different numbers of wireless vibration sensor nodes. For example, the first column may include three wireless vibration sensor nodes 2049, 2049-2 and 2049-4, whereas the second column may include four wireless vibration sensor nodes 2049-5 to 2049-8. The columns may not be arranged perpendicular to the travel 2020 of the vehicle 2006, as shown in this Figure.
The radar 2059 may be used to at least partly determine the movement estimate 2022. In other embodiments, the movement estimate 2022 may be at least partly determined by the columns of wireless vibration sensors 2049 to 2049-8 and the distance 2025 between the columns. The infrared sensor 2057 may also be used to at least partly determine the movement estimate 2232.
The Radio Frequency Identification (RF-ID) sensor 2063 may be configured to respond to a RF-ID tag to at least partly generate the vehicle identification 2232. For example, an insurance carrier may require the installation of the RF-ID tag so that the vehicles 2006 it insures may be tracked.
An optical sensor 2061 may respond to a license plate on the vehicle 2006 to at least partly generate the vehicle identification 2232.
The access point 2090 may be configured to communicate with any combination of the infrared sensor 2057, the radar 2059, the optical sensor 2061, the RF ID sensor 2063 and/or the temperature sensor 2068, either through the use of a wireless communication 2094 as previously discussed or a wireline communication 2095. As used herein, a wireline communication 2095 uses at least one wireline physical transport. Examples of wireline physical transports include, but are not limited to, one or more conductive wires and/or fiber optical conduits.
The access point 2090 may use an internal clock and/or an external clock to generate a time stamp 2234.

FIG. 28 shows the processors 2100 to 2110 may be individually and/or collectively may be implemented as one or more instances of a processor-unit 2120 that may include a finite state machine 2150, a computer 2152 coupled 2156 to a memory 2154 containing a second program system 2300, an inferential engine 2158 and/or a neural network 2160. The third apparatus may further include examples of a delivery mechanism 2230, which may include a computer readable memory 2222, a disk drive 2224 and/or a server 2226, each configured to deliver 2228 the second program system 2300 and/or an installation package 2209 to the processor-unit 2120 to implement at least part of the disclosed method and/or third apparatus. These delivery mechanisms 2230 may be controlled by an entity 2220 directing and/or benefiting from the delivery 2228 to the processor-unit 2120, irrespective of where the server 2226 may be located, or the computer readable memory 2222 or disk drive 2224 was written.
As used herein, the Finite State Machine (FSM) 2150 receives at least one input signal, maintains at least one state and generates at least one output signal based upon the value of at least one of the input signals and/or at least one of the states.
As used herein, the computer 2152 includes at least one instruction processor and at least one data processor with each of the data processors instructed by at least one of the instruction processors. At least one of the instruction processors responds to the program steps of the second program system 2300 residing in the memory 2154.
As used herein, the Inferential Engine 2158 includes at least one inferential rule and maintains at least one fact based upon at least one inference derived from at least one of the inference rules and factual stimulus and generates at least one output based upon the facts.
As used herein, the neural network 2160 maintains at list of synapses, each with at least one synaptic state and a list of neural connections between the synapses. The neural network 2160 may respond to stimulus of one or more of the synapses by transfers through the neural connections that in turn may alter the synaptic states of some of the synapses.

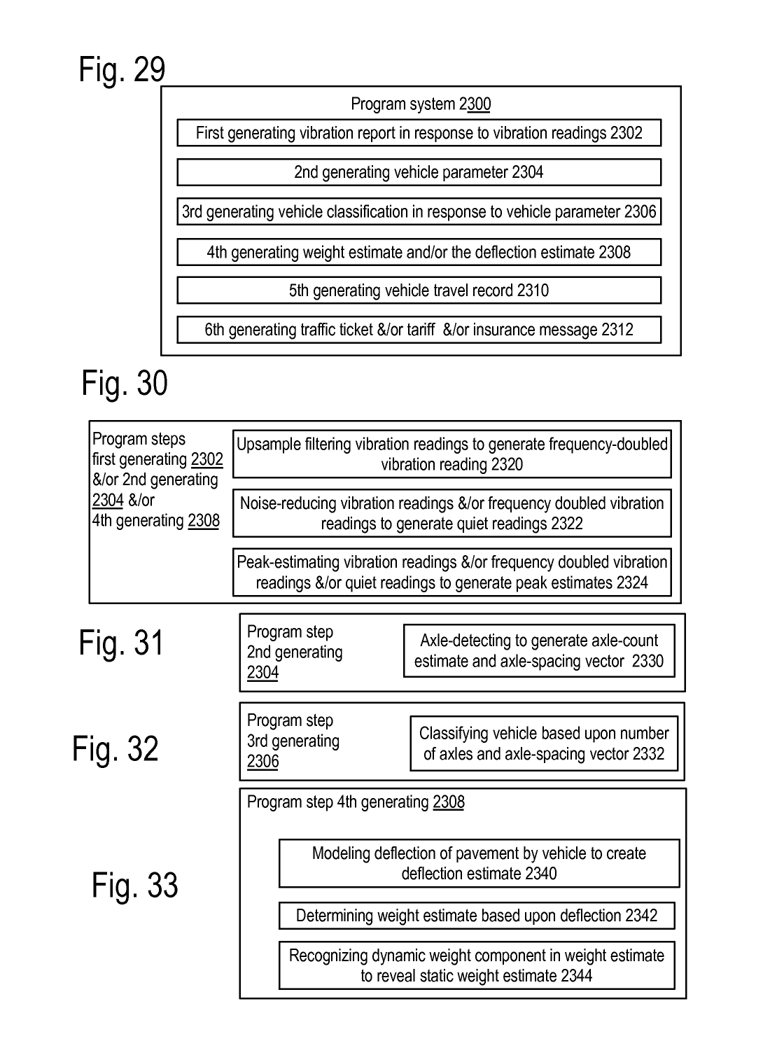

FIG. 29 shows some details of the second program system 2300 of FIG. 28 that may include one or more of the following program steps:
Program step 2302 supports first-generating the vibration report 2070 in response to the vibration readings 2062.
Program step 2304 supports second-generating at least part of the vehicle parameters 2200-2208 of the vehicle 2006 in response to the vibration readings 2062 and/or the vibration report 2070.
Program step 2306 supports third-generating the vehicle classification 2220 of the vehicle 2006 in response to one or more of the vehicle parameters 2200-2208.
Program step 2308 supports fourth-generating the weight estimate 2210 and/or the deflection estimate 2212 in response to the vibration readings 2062 and/or the vibration report 2070.
Program step 2310 supports fifth-generating the vehicle travel record 2230 for the vehicle 2006 in response to the vehicle classification 2220, the weight estimate 2210, the deflection estimate 2212, the vehicle identification 2232 and/or the vehicle movement estimate 2022.
Program step 2312 supports sixth-generating the at least one of the traffic ticket message 2250, the tariff message 2252 and/or the insurance message 2254, each for the vehicle 2006 in response to the vehicle travel record 2230.

Let ζ={t→z(t), tε(t0, t1)} denote a succession of measurement samples of the vibration 2034 as reported by the vibration sensor 2060. The vibration sensor 2060 may report these vibrations 2034 as a sequence of vibration readings 2062 arranged in time t.

FIG. 30 shows some details of the program steps 2302, 2304, and/or 2308 of FIG. 29 that may include one or more of the following program steps:
Program step 2320 supports upsample filtering at least two of the vibration readings 2062 to generate at least one frequency-doubled vibration reading. As used herein, an upsample filter generates more samples output than sample inputs. In some contexts, the upsample filter may be decomposed into upsampling and a second filtering at least part of the upsampled data stream to emulate increasing the sampling frequency without having to operate the sensor more often.
Up-sampling may be implemented in a variety of ways. For example, each input sample may be replicated one or more times. Another example, each input sample may have a fixed value, such as zero inserted between it and the next input sample. Another example, the input sample may be inserted between a running and/or windowed average of the input stream.
The second filter may be composed of two or more subband filters whose outputs are sub-sampled so that the output rate of the second filter may be the same the up-sampled input stream rate, which may then be twice or more times the input stream rate of the upsampled filter.
Program step 2322 supports noise-reducing the vibration readings 2034 and/or the frequency-doubled reading to generate at least two quiet-vibration readings. In some implementations, noise-reducing processes the sensor measurement sample C to remove frequencies above min {6, 2.47 v} Hz and frequencies below 0.1 Hz. These or similar cutoffs may be arrived at empirically.
Program step 2324 supports peak-estimating the vibration readings 2034 and/or the frequency-doubled reading and/or the quiet-vibration readings to generate at least one peak estimate. This program step may take a moving average of measurements to estimate the magnitude and time at which the pavement 2008's vibration 2034 achieves a negative and positive (local) peak, often referred to as a local extrema.

In some implementations, all measurements may filtered by the noise-reducing step before being processed by such program steps as up-filtering, peak-estimating and so on.

FIG. 31 shows an example of some details of the program steps 2304 second generating the vehicle parameter 200 of FIG. 29 that may include the following program step:
Program step 2330 supports axle-detecting to generate the axle count estimate 2204 and the axle-spacing vector 2206. This program step may take the results of the peak-estimating program step 2324, partition the sample C into different segments to isolate the response of individual vehicles 2006, and, if there is more than one embedded vibration sensors 2049, takes the maximum of the signals from different sensors to boost the signal-to-noise ratio. It may identify the occurrence of a negative or positive peak with an individual axle to generate the axle count estimate 2204 in each vehicle 2006, and knowing the movement estimate 2022 gives the spacing between axles as the axle spacing vector 2206.

FIG. 32 shows an example of some details of the program step 2306 third generating the vehicle classification 2220 of FIG. 29 that may include the following program step: Program step 2332 supports classifying the vehicle 2006 based upon the axle count estimate 2204 and the axle-spacing vector 2206 to generate the vehicle classification 2220.

This program step 2332 may classify vehicles 2006 in accord with the FHWA classification scheme in the United States.

Other examples of the details of the program step 2306 may classify vehicles 2006 in accord with a different nation's, state's and/or province's standard classification scheme.

FIG. 33 shows some details of the program steps 2308 fourth generating the weight estimate 2210 and/or the deflection estimate 2212 of FIG. 29 that may include the following program steps:
Program step 2340 supports modeling a deflection 2031 of the pavement 2008 by the vehicle 2006 to create the deflection estimate 2212.
Program step 2342 supports determining the weight estimate 2210 based upon the deflection 2031 of the pavement 2008, for instance, based upon the deflection estimate 2212.
Program step 2344 supports recognizing the dynamic weight component 2216 in the weight estimate 2210 to reveal the static weight estimate 2214. Note that in some embodiments, an averaging of the weight estimates 2210 from multiple columns of the embedded wireless vibration sensor nodes 2049 as shown in FIG. 27B may further generate the static weight estimate 2214. Also note, that determining the dynamic weight component 2216 may be performed and the weight estimate 2210 combined with the dynamic weight component 2216 may be used by the second system 2010 to reveal the static weight estimate 2214.

Consider the following model of the deflection 231 of the pavement 2008: Assume the pavement 2008 is an Euler beam. The deflection 2031 is denoted by y(x, t) at position x and time t in response to a load on a single axle, say one of 2021, 2022 or 2023 of FIG. 20. The deflection 2031 may approximated as

$$z ( t ) = η \times \frac{{\partial }^{2} y}{\partial {t}^{2}} ( x , t ) + w ( t ) \qquad ( 2 )$$

Here F may denote the axle load, ω0 may denote the fundamental frequency of the axle suspension second system, v may denote the vehicle speed, γ may denote a constant, and the pavement response ψ* may have a functional form as a complex function of position and time; both γ and ψ* depend upon parameters of the pavement 8 such as stiffness. The signal 2034 measured by the vibration sensor 2060 placed at x may be approximated as

$$y ( x , t ) = F {γ}^{- 1} Re [ {Ψ}^{*} ( υ t - x ) {e}^{i {ω}_{0} t} ] \qquad ( 1 )$$

Consider some of the signal processing aspects of the second system 2010 and its processors 2100-2110 in which η is a constant, w is measurement noise originating in the electronic circuitry of the wireless vibration sensor node 2049 and random pavement 2008 vibrations 2034. Differentiating (1) twice shows that in this model acceleration is linear in axle load F and v². The displacement of a real pavement 2008 may not follow the ideal model, however the acceleration (and displacement) may often increase monotonically with the load F and speed v. Also, the greater the vehicle speed v, the higher will be the frequencies in the signal.

The disclosed method may include steps initializing at least one of the third apparatus 2010, 2100-2110, 2049 and/or 2090, and/or operating at least one of the third apparatus and/or using at least one of the third apparatus to create at least one of the vibration report 2070, the vehicle parameter 2200-2208, the weight estimate 2210, the deflection estimate 2212, the vehicle classification 2220, the vehicle travel record 2230, the traffic ticket message 2250, the tariff message 2252, and/or the insurance message 2254, each for the vehicle 2006. The vibration report 2070, the vehicle parameter 2200-2208, the weight estimate 2210, the deflection estimate 2212, the vehicle classification 2220, the vehicle travel record 2230, the traffic ticket message 2250, the tariff message 2252, and/or the insurance message 2254 are produced by various steps of the method.

Modeling the deflection 2031 of the pavement 2008 may integrate twice the noise-reduced response for each axle 2021, 2022, and/or 2023 to create the deflection estimate 2212. The peak deflection and speed can be used in a lookup table to estimate axle load, which may represent the weight estimate 2210. The table may be built using calibrated vehicles 2006.

The inventors have performed field tests using a second system 2010 similar to the second system 2010 shown in FIG. 27. Test results from three different sites indicate that the measurements are repeatable, and the second system 2010 correctly detects axles, and estimates pavement deflection 2031 accurately and axle load well. The second system 2010 directly measures deflection 2031 of the pavement 2008 as the vehicle 2006 goes over it, unlike current WIM stations that measure deflection of a plate, isolated from the pavement. The second system 2010 can be installed in minutes and takes up no space in or next to the lane 2002. It may be used in settings where current WIM stations are inappropriate, including weighing vehicles 2006 on urban streets, and a vehicle weight-based tolling second system.

Regarding the Third Aspect:

This disclosure relates to micro-radars, radar antennas, sensor nodes adapted to interact with a micro-radar, and processors adapted to respond to the micro-radar, as well as components and systems supporting communications between the micro-radars and the processors. The processors and systems may further support traffic analysis and management of moving and/or stationary vehicles. In some embodiments the micro-radar, sensor nodes, processors and/or system may support production management.

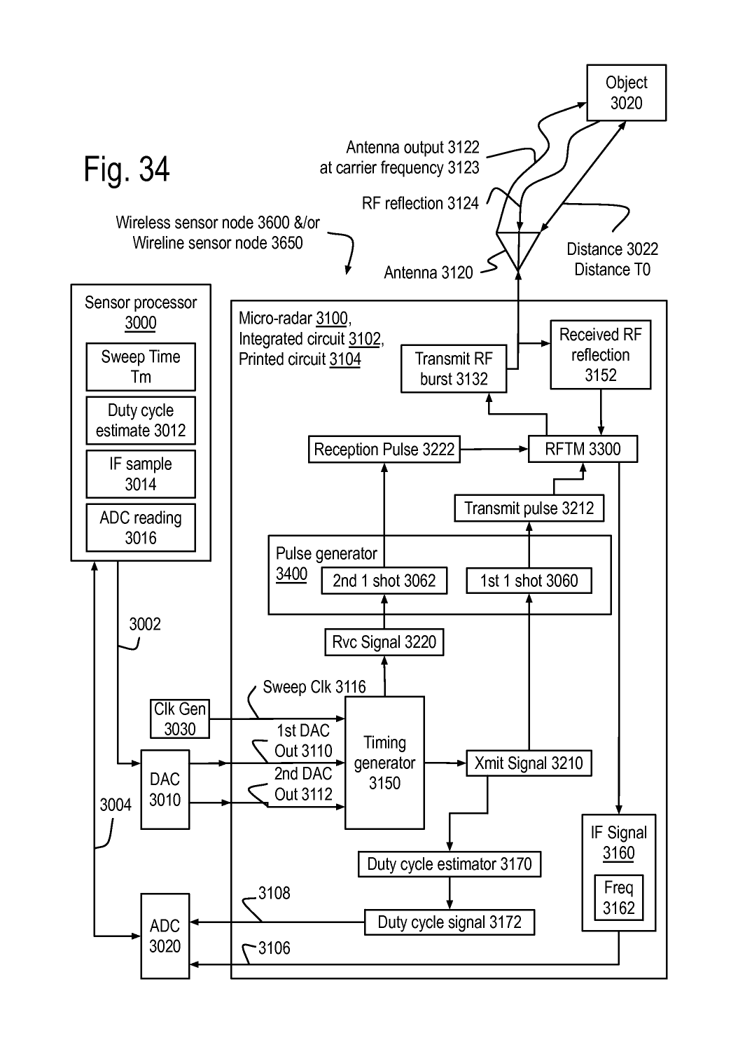

FIG. 34 shows a simplified block diagram of an example of a wireless sensor node 3300 and/or a wireline sensor node 3310 that may include a sensor processor 3000 configured to operate a micro-radar 3100 based upon a first DAC output 3110 and second DAC output 3112.
The micro-radar 3100 is a radar that may be adapted to generate an antenna output 3122 of less than or equal to (no more than) ten milliWatts (mW) and responds to at least two outputs of a Digital to Analog Converter (DAC), which will be referred to as a DAC output.
An object 3020 may be situated at a distance 3022, for example a distance T0, from an antenna 3120 interacting with the micro-radar 3100. In many situations, the antenna and the micro-radar may be considered as located at one location, but in other situations, there may be some distance between them. To simplify this discussion, only the distance 3022 from the antenna will be discussed. The object 3020 may reflect the antenna output 3122 to generate a RF reflection 3124. The micro-radar 3100 may be adapted to generate a received RF reflection 3152 from the RF reflection 3124.
The micro-radar may use a timing generator 3150 adapted to respond to the two DAC outputs 3110 and 3112 to generate a transmit signal 3210 and a reception signal 3220 that stimulate a Radio Frequency (RF) transceiver/mixer (RFTM) 3300 to generate the antenna output 3122 and to down convert an Intermediate Frequency (IF) signal 3160 based upon and proportional to the received RF reflection 3152.

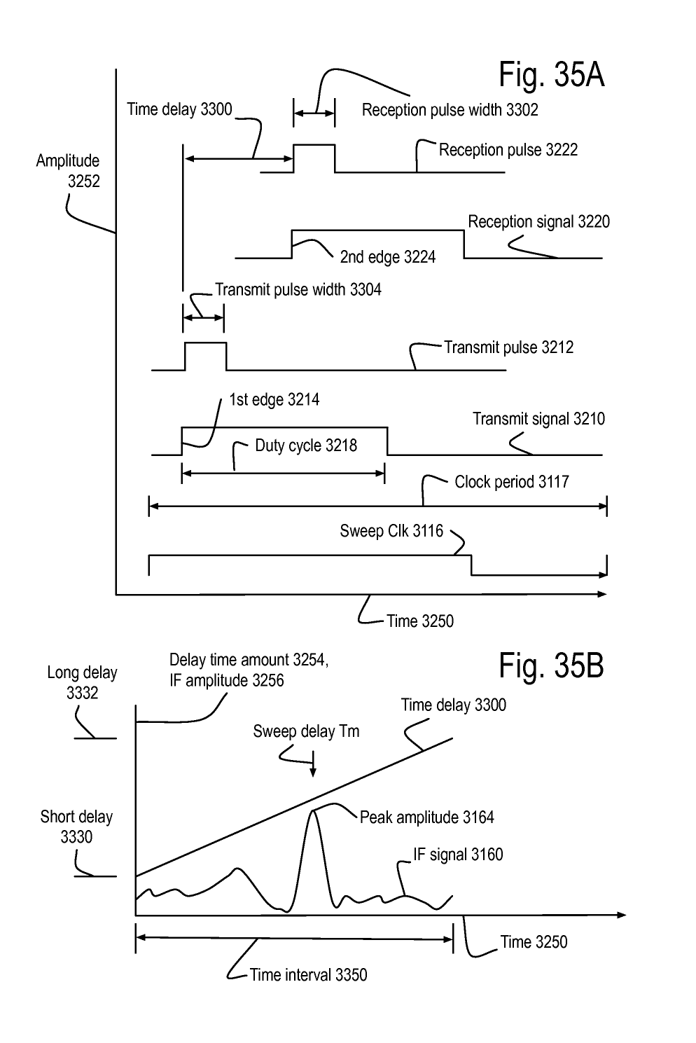

Consider the micro-radar 3100 response to the first DAC output 3110 and to the second DAC output 3112 over the clock period 3117 of a sweep clock 3116.
The sweep clock 3116 may be generated by a separate clock generator 3030. In other implementations, the micro-radar and/or the sensor processor 3000 may include the clock generator.
The timing generator 3150 may respond to the first DAC output 3110 by generating a transmit signal 3210 over the clock period 3117 of sweep clock 3116 as shown in FIG. 35A, which will be discussed shortly.
The timing generator 3150 may respond to the second DAC output 3112 by generating a reception signal 3220 with a time delay 3300 from the transmit signal over the sweep clock 3116 period 3117, also shown in FIG. 35A.
A first one-shot multi-vibrator 3060 may respond to the transmit signal 3210 by generating the transmit pulse 3212.
A second one-shot multi-vibrator 3062 may respond to the reception signal 3220 by generating the reception pulse 3222.
The RFTM 3300 may respond to the transmit pulse 3210 by generating a transmitted Radio Frequency (RF) burst 3132 for delivery to the antenna 3120 to generate the antenna output 3122.
The RFTM 330 may mix a received RF reflection 3152 with the transmit RF burst 3132, in response to the reception pulse 3220, to generate the IF signal 3160 with a peak amplitude 3164 at a sweep delay Tm for a distance T0 of the object 3020 from the antenna 3120.
The frequency 3160 of the IF signal 3160 is preferably about one over the compression ratio multiplied by the carrier frequency 3123 of the antenna output 3122, where the compression ratio is about one million.

A pulse generator 3400 may be used to respond to the transmit signal 3210 to generate the transmit pulse 3212 and to respond to the reception signal 3220 to generate the reception pulse 3222. The transmit signal may further stimulate a first one shot multi-vibrator 3060 to at least partly generate the transmit pulse. The reception signal may further stimulate a second one-short multi-vibrator 3060-2 to at least partly generate the reception pulse. Note that in some implementations, the reception pulse may include the transmit pulse occurring before at a time delay 3300 before it. The time delay will be shown in FIG. 35A. FIG. 35A will show the reception pulse not including the transmit pulse.

Before discussing the timing relationships in FIGS. 35A and 35B, there are two questions to answer: Where does the compression ratio show up in this apparatus? And what is the relationship of the duty cycle 3218 of the transmit signal 3210 to compression ratio and the frequency 3162 of the IF signal 3160?

First, here is how the compression ratio shows up. The carrier frequency 3123 of the antenna output 3122 is in the GigaHerz (GHz) range. For example, in the inventor's products, which include wireless sensor nodes 3310, the carrier frequency is about 6.3 GHz. The return times for the antenna output 3122 to travel the distance T0 of 6 feet to the object 3020 and return are as the RF reflection are about 12 nanoseconds.
But the system clock for the sensor processor 3000 is about 32 KHz. This clock frequency is set low to conserve on power stored in the wireless sensor node 3310. The sensor processor cannot directly detect the reception time Tm of the RF reflection 3124 without consuming a lot more power than can be afforded.
There are RFTM 3212 and similar micro-radar 3100 circuits that held a promise of meeting these needs, in that the frequency 3162 of the IF signal 3160 is one millionth of the carrier frequency 3123, making the IF frequency about 6.3 KHz, which is within the operating frequency of the sensor processor 3000.
Because of the compression ratio, the frequency 3162 of the IF signal 3160 frequency 3162 is small enough that sensing it can be done efficiently enough for a wireless sensor node 3300.

Here is where the duty cycle and its relationship to the compression ratio and the frequency 3162 of the IF signal 3160 shows up:
The inventor obtained some samples of micro-radars, and they worked.
However, when he made then some that had the same schematic and they did not work. It turned out the there were manufacturing variations in the components that changed the compression ratio and consequently, the frequency 3162.
After much experimentation, he found that by adding DAC outputs 3110 and 3112 to generate the transmit signal 3210 and the receive signal 3220, and measuring the duty cycle of the transmit signal, he could control the compression ratio at the same time he controlled the duty cycle.
This also allowed a program to be executed on the sensor processor 3000 that could change the first DAC output 3110 until the duty cycle 3218 was within a factional range of the clock period 3117 of the sweep clock 3116. For instance, he found that if the ratio of the duty cycle to the clock period was 50%, the frequency 3162 of the IF signal 3160 was about 10 KHz, whereas if the ratio was about 70%, the frequency was about 6.3 KHz.
There is no immediate theory that seems to account for this phenomena, but experimentally it has been found to be true.
Further, field testing of the wireless sensor nodes 3310 has revealed that the compression ratio and therefore the frequency 3162 of the IF signal 3160 of these micro-radars 3100 are also sensitive temperature fluctuations. However, it was again discovered that if the first DAC output 3110 was adjusted until the duty cycle estimate 3012 was again adjusted until it was in the vicinity of 70%, the frequency 3162 of the IF signal 3160 was again in the range of 6.3 KHz.

Before completing the discussion of FIG. 34, the timing relationships involved with this micro-radar will be shown and discussed in FIGS. 35A and 35B.

FIG. 35A shows a timing diagram of the relationship between the sweep clock 3116, the transmit signal 3210 and the reception signal 3220 as generated by the timing generator 3150 and used by the RFTM 3300, including the time delay 3300 between the signals and/or the pulses, the pulse widths and duty cycle 3218.
The transmit signal 3210 and the reception signal 3220 may be generated once in every cycle of the sweep clock 3116 by the timing generator 3150. The sweep clock has a clock period 3117, which in some situations is about 6.3 MHz.
The duty cycle 3218 of the transmit signal 3210 is the time in the clock period 3117 in which the signal is high, which is often referred to as logic ‘1’.
The transmit pulse 3212 is initiated in response to a first edge 3214 of the transmit signal 3210. Since the micro-radar 3100 circuitry is so much faster than the sensor processor 300 and the wireless sensor node 3300 in general, there are no delays shown between the first edge 3214 and the transmit pulse 3212 starting.
The reception pulse 3222 is initiated in response to a second edge 3224 of the reception signal 3220, again shown with no delays. However, there is a time delay 3300 between the first edge 3214 and the second edge 3224, which leads to essentially the same delay between the transmit pulse 3212 and the reception pulse 3222.
The transmit pulse width 3304 is shown as the active high width of the transmit pulse 3210. The reception pulse width 3302 is shown as the active high width of the reception pulse 3220. Both the transmit pulse with 3304 and the reception pulse width 3302 are about the same, and in some situations may be about 4 ns.

FIG. 35B shows a timing diagram sweep of the time delay 3300 from a short delay 3330 to a long delay 3332 over a time interval 3350, as well as the IF signal 3160 over the time interval with a peak amplitude 3164 at a sweep delay Tm corresponding to the distance T0 of the object 3020 from the antenna 3120 as shown in FIG. 34. The time interval may see the sweep start at the short delay and progress to the long delay as is shown. In other implementations, the time interval may see the opposite, that the sweep starts at the long delay progresses to the short delay.

Since the pulse widths 3302 and 3304 are essentially the same, for example, both about 4 ns, avoiding a collision between sending the antenna output 3122 and receiving the RF reflection 3124, can be served by setting the short delay 3330 to 4 ns. Setting the long delay 3332 to 20 ns after the short delay leads to setting the long delay to 24 ns, allowing for seep delays Tm that corresponding to traversing to and from the object at a distance roughly 10 feet, which is sufficient for many applications of the micro-radar 3100.

Returning to the discussion of FIG. 34 given the above discussion of the timing issues. This disclosure allows the sensor processor 3000 to use an Analog to Digital Converter (ADC) 3020 less than 20 thousand times a second and yet determine the distance T0 very accurately, while being able to calibrate itself to account for variations in manufacturing, temperature and other ambient conditions.

It should be noted that the micro-radar 3100 and/or the RFTM 3200 may be implemented as at least part of an integrated circuit 3102 and/or a printed circuit 3104. Through the use of the first DAC output 3110 and the second DAC output 3112, initial and later calibration of the micro-radar 3100, the integrated circuit 3102 and/or the printed circuit 3104 may be cost effectively performed, thereby minimizing production test costs and improving reliability in varying field conditions.

The micro-radar 3100 may be operated by the sensor processor 3000 through interactions with the DAC and an Analog to Digital Converter (ADC) 3020. The setting of the DAC outputs 3110 and 3112 have been described to some extent.
A duty cycle estimator 3170 may respond to the transmit signal 3210 to generate a duty cycle signal 3172 presented to an Analog to Digital Converter (ADC) to generate an ADC reading used to calculate a duty cycle estimate 3012.
The IF signal 3160 may be sampled by the ADC 3020 to create a possibly different ADC reading 3016 used to generate the IF sample 3014 at an estimated sweep time Tm.

FIG. 34 shows one DAC 3010 generating both the first DAC output 3010 and the second DAC output 3112 and being coupled 3002 to the sensor processor 3000.
Various implementations of the DAC 3010 may be used to generate the first DAC output 3110 and/or the second DAC output 3112. These implementations of the DAC 3010 do not have to be the same, may differ in resolution and sampling rate. However, the discussion will proceed to illustrate one DAC generating both the first and second DAC outputs. This is not intended to limit the scope of the claims. It is done for the sake of simplifying the discussion. Also, the resolution of the DAC outputs 3110 and/or 3112 may be at least 10 bits, and in some situations may be preferred to be more than 10 bits.
The coupling 3002 between the sensor processor 3000 and the DAC 3010 today is preferably a wireline coupling, frequently involving one or more electrically conductive materials. However other implementations may be preferred. For example, the coupling may also implement an optical coupling which might not be electrically conductive.

FIG. 34 also shows the sensor processor 3000 second coupled 3004 to an Analog to Digital Converter (ADC) 3020. The sensor processor and/or the wireless sensor node 3300 and/or the wireline sensor node 3310 may be adapted and/or configured to use the ADC 3120 in one or more of the following ways:
The ADC 3020 may respond to the duty cycle signal 3212 and the interactions of the sensor processor 3000 through the second coupling 3004 to generate a duty cycle estimate 3012 in the sensor processor, and/or
The ADC 3020 respond to the IF signal 3160 and the interactions of the sensor processor 3000 through the second coupling 3004 to generate an IF sample 3014 in the sensor processor.
Various implementations of the ADC 3020 may be used to generate the duty cycle estimate 3012 and/or the IF sample 3014. These implementations of the ADC 3020 do not have to be the same, may differ in resolution and sampling rate. However, the discussion will proceed to illustrate one ADC generating both the duty cycle estimate 3012 and the IF sample 3014. This is not intended to limit the scope of the claims. It is done for the sake of simplifying the discussion. Also, the resolution of the ADC 3020 may be at least 10 bits, and in some situations may be preferred to be more than 10 bits.
The second coupling 3004 between the sensor processor 3000 and the ADC 3020 today is preferably a wireline coupling, frequently involving one or more electrically conductive materials. However other implementations may be preferred. For example, the second coupling may also implement an optical coupling which might not be electrically conductive.
The interactions across the second coupling 3004 may include a selection of an analog input port and a strobing of the ADC 3020 to provide data to be used as the duty cycle estimate 3012 and/or the IF sample 3014.

The micro-radar 3100 may include a first ADC coupling 3106 of the IF signal 3160 to the ADC 3160, and/or a second ADC coupling 3108 of the duty cycle signal 3212 to the ADC 3160.

In some embodiments, the sensor processor 3000 may include the DAC 3010 and/or include the ADC 3020. Whereas in other embodiments, the sensor processor, the DAC and the ADC may be separate components fastened to a printed circuit 3104, possibly containing all or part of the micro-radar 3100, and the first coupling 3002 and the second coupling 3004 may be electrical traces on and/or through the printed circuit.

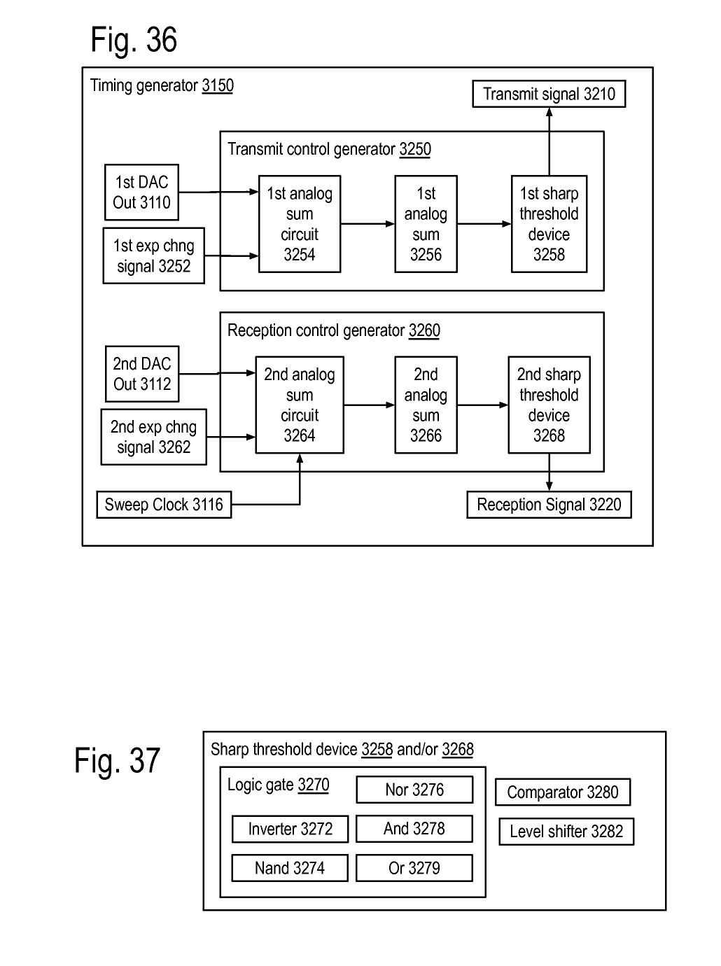

FIG. 36 shows some details the micro-radar 3100, in particular the timing generator 3150 of FIG. 34, including a transmit control generator 3250 responding to the first DAC output 3110 and a reception control generator 3260 responding to the second DAC output 3112.
The transmit control generator 3250 may include a first analog sum 3256 of a first exponentially changing signal 3252 and the first DAC output 3110 triggering a first sharp threshold device 3258 to generate the transmit signal 3210 with a duty cycle 3218 as shown in FIG. 35A. The transmit signal may stimulate the duty cycle estimator 3170 to generate the duty cycle signal 3172 as shown in FIG. 34. Note that the first analog sum may be generated by a first analog sum circuit 3256.
The reception control generator 3260 may includes a second analog sum 3266 of the second DAC output 3112, a second exponentially changing signal 3262 and the sweep clock signal 3116 triggering a second sharp threshold device 3268 to generate the reception signal 3220. The second analog sum may be generated by a second analog sum circuit 3266.
The first and second analog sum circuits 3254 and 3264 may be implemented in a wide variety of ways, including through the use of differential amplifiers and/or weighted resistor networks designed based upon Ohm's Law to generate the analog sum 3256 and/or 3266.
The first exponentially changing signal 3252 is used to generate the transmit signal 3210, and will tend to need a fast time of change, possibly changing from a saturation to depleted state in a few nanoseconds.
The second exponentially changing signal 3262 is used to generate the time delay 3300 sweep from a short delay 3330 to a long delay 3332 over the time interval 3350, which may be on the order of 20 ms.
Circuitry to generate the first exponentially changing signal 3252 and/or the second exponentially changing signal 2166 may be implemented based upon capacitor charging and/or discharging across a resistor, which may be further implemented with various components of one or more transistors acting as the capacitor and/or the resistor.
In some embodiments, the exponentially changing signals 3252 and/or 3262 may be generated through piecewise linear behavior of threshold switching components. Such signals may not change in an exactly exponential fashion, but will display a distinctive change in the rate of change which will be monotonically increasing or monotonically decreasing within one sweep clock 3116 period 3117.
The first exponentially changing signal 3252 may have an RC delay of 20 ns. The second exponentially changing signal 3262 may have an RC decay of 20 ms. The delay sweep shown in FIG. 35B may be controlled by a signal set by the sensor processor 3000 that may short the capacitor that generates the second exponentially changing signal.

The transmit pulse 3212 use only the high speed RC signal and the reception pulse 3222 may use both the reception signal 3220 and the transmit signal 32210.

FIG. 37 shows the first sharp threshold device 3258 and/or the second sharp threshold device 3268 may include at least one instance of a logic gate 3270, a comparator 3280 and/or a level shifter 3282. The logic gate 3272 which may be implemented as an inverter 3272, a NAND gate 3274, a NOR gate 3276, an AND gate 3278, and/or an OR gate 3279. In situations where the logic gate has more than one input, the analog sum 3256 or 3266 may be supplied to one or more of the inputs. Any remaining inputs may be tied to logic 1 or 0 as needed.

The simplicity of using basic power logic gates 3270 instead of more power consuming comparators 3280 is very desirable but adds to the need to calibrate out the part to part voltage threshold differences found in these gates. Threshold variations may cause two major issues in the design: the IF signal 3160 frequency 3162 may vary based on the part of the RC curve that is used as the switching point, and the time delay 3300 of the transmit pulse 3212 versus the reception pulse 3222 may create uncertainty in the detection distance t0 versus sweep delay Tm relationship.

To address these situations, a method of calibrating the micro-radar 3100 that can adjust for both of these uncertainties and compensate them over temperature without significant power consumption or specially calibrated parts was developed. This method will be described later in FIG. 43 in terms of a program system 3500 that may instruct a computer 3852.

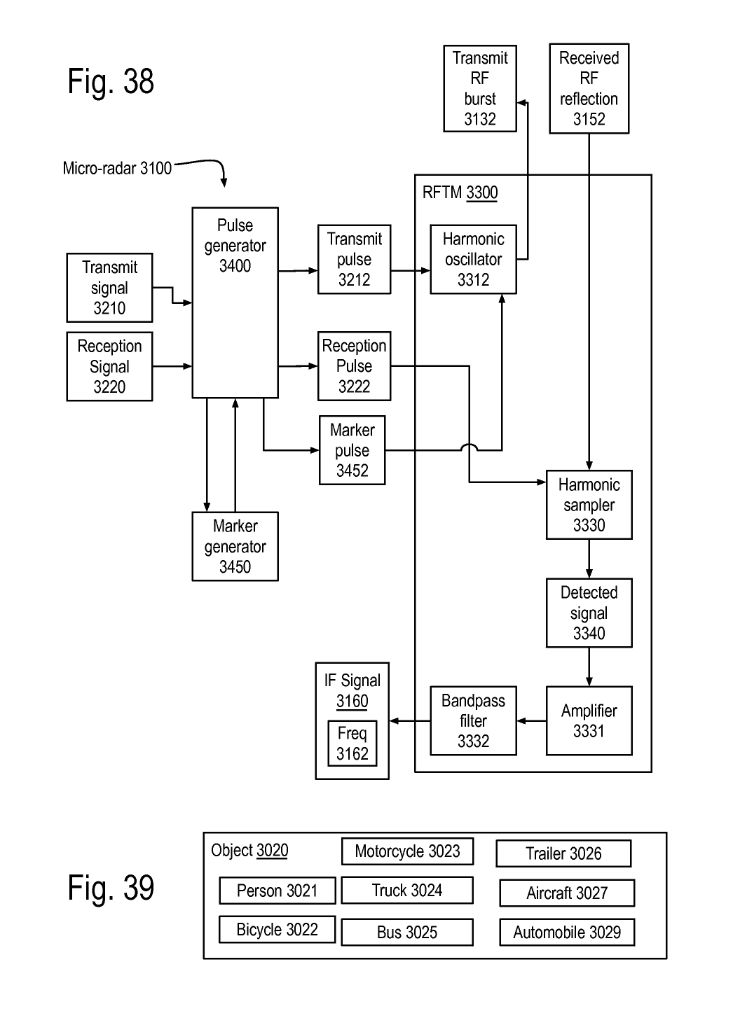

FIG. 38 shows an example of the RFTM 3300 of FIG. 34 based upon the circuitry of U.S. Pat. No. 6,414,627 (hereafter referred to as the '647 patent). In this example, the carrier frequency 3123 of antenna output 3122 is 24 GHz. A single antenna 3120 is used as shown in FIG. 34. The RFTM emits 24 GHz RF sinewave packets and samples echoes with strobed timing such that the illusion of wave propagation at the speed of sound is observed, thereby forming an ultrasound mimicking radar (UMR). A 12 GHz frequency-doubled transmit oscillator in the RFTM is pulsed by the transmit pulse 3212 a first time to transmit a 24 GHz harmonic burst as the transmit RF burst 3132 and pulsed by the reception pulse 3222 a second time to produce a 12 GHz local oscillator burst for a sub-harmonically pumped, coherently integrating sample-hold receiver (homodyne operation). The time between the first and second oscillator bursts is swept as shown in FIG. 35B to form an expanded-time replica of echo bursts at the receiver output as the IF signal 3160.

A random phase RF marker pulse may be interleaved with the coherent phase transmitted RF antenna output 3122 to aid in spectrum assessment of the micro-radar's 3100 nearly undetectable emissions. The low-cost micro-radar 3100 can be used for automotive backup and collision warning, precision radar rangefinding for fluid level sensing and robotics, precision radiolocation, wideband communications, and time-resolved holographic imaging.

The RFTM 3300 may be implemented as a transmit oscillator and as a swept-in-time pulsed receive local oscillator. This dual function use of one oscillator eliminates the need for two microwave oscillators and facilitates operation with only one antenna for both transmit and receive functions. Further, it assures optimal operation since there are no longer two oscillators that can go out of tune with each other (in a two oscillator system, both oscillators must be tuned to the same frequency).

The transmit RF burst 3132 may be short, perhaps on the order of a few nanoseconds and sinusoidal, is transmitted to as the antenna output 3122 and reflected as the RF reflection 3124 from the object 3020. Shortly after transmission, the same RF oscillator used to generate the transmit pulse is re-triggered to produce a local oscillator pulse (homodyne operation) as the reception pulse, which gates a sample-hold circuit in to produce a voltage sample. This process may be repeated at a several megaHertz rate as controlled by the sweep clock 3116. With each successive repetition, another sample may be taken and integrated with the previous sample to reduce the noise level. Also, each successive local oscillator pulse is delayed slightly from the previous pulse such that after about the time interval 3350, the successive delay increments add up to a complete sweep or scan from the short delay 3330 to the long delay 3332, for example, of perhaps 100-nanoseconds or about 15 meters in range. After each scan, the local oscillator delay is reset to a minimum and the next scan cycle begins.

The micro-radar 3100 produces a sampled voltage waveform on a millisecond scale that is a near replica of the RF waveform on a nanosecond scale. This equivalent time effect is effectively a dimensionless time expansion factor. If the compression ratio is set to 1-million, 24 GHz sinewaves are output from the micro-radar as 24 kHz sinewaves. Accordingly, the radar output can be made to appear like an ultrasonic ranging system. In addition to having the same frequency, e.g., 24 kHz, a 24 GHz radar actually has the same wavelength as a 24 kHz ultrasonic system. In addition, the range vs. round-trip time is the same (in equivalent time for the radar, of course).

The emission spectrum from the RFTM 3300 is very broad and often implemented as an Ultra Wide-Band (UWB) compliant signal generator. Sometimes, a narrowband, incoherent RF marker pulse may interleaved with the short coherent RF pulses used for ranging to produce a very visible spectrum with an identifiable peak, i.e., carrier frequency 3123. However, the marker pulse may create spurious echoes. Accordingly, the marker pulse may be randomized in phase so its echoes average to zero in the RFTM. At the same time, the desired ranging pulses as the antenna output 3122 and the RF reflection 3124 phase-coherently integrating from pulse to pulse into a clean IF signal 3160.

FIG. 38 shows some details of the micro-radar 3100 and the RFTM 3300 of FIG. 34 adapted to operate as in the '647 patent. A harmonic oscillator 3312 receives the transmit pulse 3212 from the transmit signal 3210 via pulse generator 3400 and produces RF burst pulses as the transmit RF burst at the antenna 3120 as shown in FIG. 34.

In some implementations the transmit signal 3210 may be a 1-10 MHz square wave that is passed through pulse generator to form about 1 ns wide transmit pulses 3212 with rise and fall times on the order of 100 picoseconds (ps). The transmit pulse 3212 and the reception pulse 3222 may be clock pulses with very fast rise and fall times. The transmit pulse 3212 and pulse generator 3400 may together be viewed as a clock signal generator. These short pulses bias-on the harmonic oscillator 3312, which is designed to start and stop oscillating very rapidly as a function of applied bias. The oscillations of the transmit pulses 3212 are phase coherent with the drive pulses, the phase of the RF sinusoids of the transmit RF burst 3132 relative to the drive pulse remains constant, i.e., coherent, each time the harmonic oscillator 3312 is started—there is no significant clock-to-RF jitter. However, as will be discussed below with reference to the marker generator 3450, separate marker pulses M may have a random phase relative to the clock.

A high degree of phase coherence for the transmit pulse 3212 may be obtained with a very fast risetime transmit pulse 3212 that shock-excites the harmonic oscillator 3312 into oscillation. Accordingly, the pulse generator 3400 may have transition times of about 100 ps to ensure coherent harmonic oscillator startup.

The harmonic oscillator 3312 may operate at a fundamental frequency of 12.05 GHz with a second harmonic at 24.1 GHz. A frequency of 24.1 GHz or thereabouts may be preferred since commercial and consumer devices such as radar rangefinders can operate in the 24.0-24.25 GHz band without a license. The transmitted RF bursts 3132 may be typically 12 cycles long at a carrier frequency 3123 of 24.1 GHz

The reception signal 3220 may be a 1-10 MHz squarewave passed through pulse generator 3400 to form the reception pulse 3222 as about 1 ns wide pulses with rise and fall times below 100 ps. These short pulses bias-on the harmonic oscillator 3312 to generate the reception pulse 3222 in a similar fashion to the transmit pulses 3212 to form the reception pulses as 0.5 ns wide gate pulses. The reception pulses 3222 gate the harmonic sampler 3330 at typical frequency of 12 GHz to sample the received RF reflection 3152.

The harmonic sampler 30 develops a detected signal 3332, representing the coherent integration of multiple gatings of sampler 30, which is amplified by a low frequency amplifier 3331 and filtered in bandpass filter 3332 to produce the IF signal 3160 signal.

The micro-radar 3100 may include a marker generator 3450. The marker generator may be triggered by pulses from the pulse generator 3400 to form marker pulses 3452 which are much wider than the transmit pulse 3212 or the reception pulse 3222. Due to the width of the marker pulses 3452, the radiated spectrum becomes relatively narrow, since the emission spectrum is roughly related by 1/PW, where PW is the width of the emitted pulses. One purpose of the narrow marker pulse spectrum is to aid in identifying the RF carrier frequency 3123 and spectral width of the transmitted pulses 3212 and/or the transmit RF burst 3132.

Note that in some implementations, the amplifier 3331 and the bandpass filter 3332 may be implemented by a single component. Such a component may be a fixed gain (possibly about 45 dB) 6 pole bandpass amplifier centered at 6.5 kHz with a bandwidth of approximately 24 kHz. In other implementations, fewer gain stages may be used with the filtering reduced to say 4 poles.

FIG. 39 shows some examples of the object 3020 as at least one of a person 3021, a bicycle 3022, a motorcycle 3023, an automobile 3029, a truck 3024, a bus 3025, a trailer 3026 and/or an aircraft 3027.

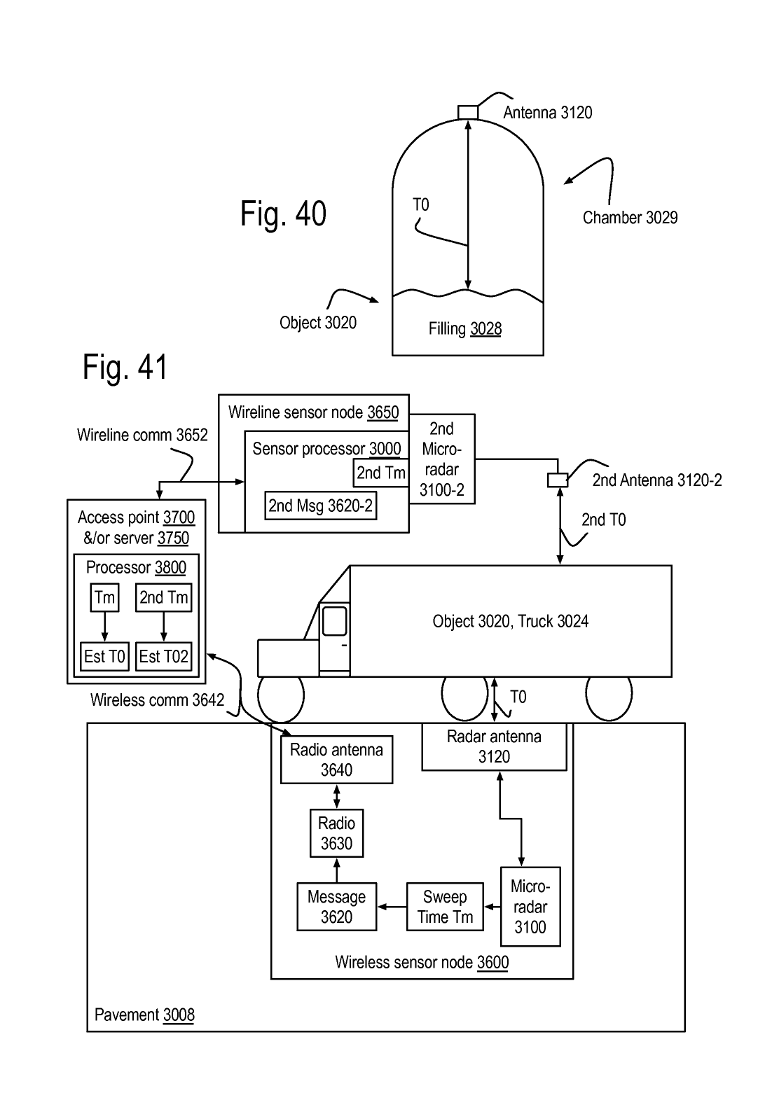

FIG. 40 shows some examples of the object 3020 as a surface of a filling 3028 of a chamber 3029, where the filling may be a liquid and/or granules such as grain, powders and/or sand. The chamber may be used for storeage and/or mixing of components which may be considered as the filling in some implementations.

FIG. 41 shows some other apparatus embodiments that involve the micro-radar 3100 of FIG. 34, including but not limited to, the wireless sensor node 3600, the wireline sensor node 3650, each of which may send messages 3620 and/or 3620-2 regarding the sweep delay Tm sampled by their respective micro-radar 3100 to an access point 3700 and/or a server 3750. A processor 3800, which may be separate from, or included in the access point and/or the server may respond to one or both messages to generate an estimated distance approximating the distance T0 of the relevant radar antenna 3120 or 3120-2 from the object 3020, in this example, a truck 3024.

The wireless sensor node 3600 may include a radio 3630 coupled to a radio antenna 3640 to wirelessly communicate 3642 the message 3620 to the access point 3700. As shown in this Figure, the processor 3800 may be included in the access point and configured to use the message 3620 to create the sweep time Tm, local to the access point and/or the processor. The processor may further be configured to respond to the sweep time Tm by generating an estimated T0 distance of the radar antenna to the object 3020. The radio antenna 3640 and the radar antenna 3120 may be located near the top of the wireless sensor node 3600, which may be embedded in the pavement 3008.

The wireline sensor node 3650 may not include the second micro-radar 3100-2, but may communicate with it in a fashion similar to that described with regards FIG. 34. The second antenna 3120-2 may or may not be located close to the micro-radar. The wireline sensor node may operate the second micro-radar to generate a second sweep time Tm corresponding to a second distance T0 of the second antenna from the object 3020. The wireline sensor node may wireline communicate 3652 with the server 3750 and/or the access point 3700. The processor 3800 may be included in the server and may be configured to respond to reception of the second message by generating the second sweep time Tm. The processor may further respond by generating a second distance estimate T02 based upon the second sweep time Tm.

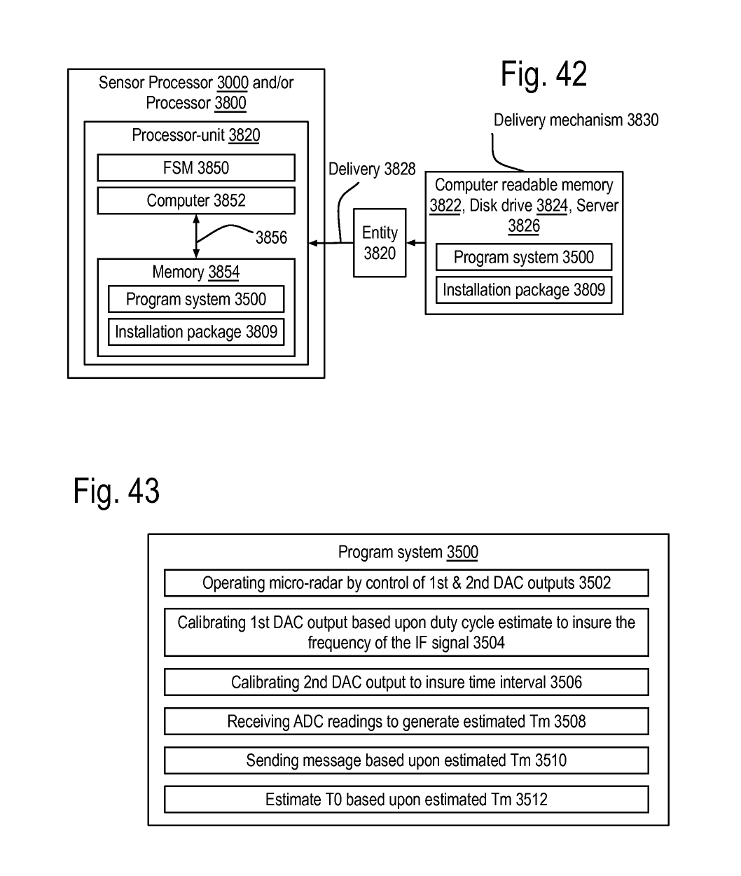

FIG. 42 shows some details of at least one of the sensor processor 3000 and/or the processor 3800 may be individually and/or collectively may be implemented as one or more instances of a processor-unit 3820 that may include a finite state machine 3850, a computer 3852 coupled 3856 to a memory 3854 containing a program system 2300, an inferential engine 3858 and/or a neural network 3860. The apparatus may further include examples of a delivery mechanism 3830, which may include a computer readable memory 3822, a disk drive 3824 and/or a server 3826, each configured to deliver 3828 the second program system 2300 and/or an installation package 3809 to the processor-unit 3820 to implement at least part of the disclosed method and/or third apparatus. These delivery mechanisms 3830 may be controlled by an entity 3820 directing and/or benefiting from the delivery 3828 to the processor-unit 3820, irrespective of where the server 3826 may be located, or the computer readable memory 3822 or disk drive 3824 was written.
As used herein, the Finite State Machine (FSM) 3850 receives at least one input signal, maintains at least one state and generates at least one output signal based upon the value of at least one of the input signals and/or at least one of the states.
As used herein, the computer 3852 includes at least one instruction processor and at least one data processor with each of the data processors instructed by at least one of the instruction processors. At least one of the instruction processors responds to the program steps of the second program system 2300 residing in the memory 3854.
As used herein, the Inferential Engine 3858 includes at least one inferential rule and maintains at least one fact based upon at least one inference derived from at least one of the inference rules and factual stimulus and generates at least one output based upon the facts.
As used herein, the neural network 3860 maintains at list of synapses, each with at least one synaptic state and a list of neural connections between the synapses. The neural network 3860 may respond to stimulus of one or more of the synapses by transfers through the neural connections that in turn may alter the synaptic states of some of the synapses.

FIG. 43 shows a flowchart of the program system 3500 of FIG. 41 including at least one of the shown program steps.
Program step 3502 supports operating the micro-radar 3100 by control of the first DAC output 3110 and the second DAC output 3112.
Program step 3504 supports calibrating the first DAC output 3110 based upon the duty cycle estimate 3012 to insure the frequency 3162 of the IF signal 3160. Note that this program step may be used to help calibrate the second DAC output 3112, by measuring the duty cycle of the reception signal 3220 with another ADC 3020 input. This program step may by executed every so often, possibly every few seconds or minutes, to compensate for temperature or other ambient condition chages.
Program step 3506 supports calibrating the second DAC output 3112 to insure the time interval 3350 sweeps between the short delay 3330 and the long delay 3332.
Program step 3508 supports receiving one or more ADC readings 3016 to generate an estimated sweep time Tm.
Program step 3510 supports sending a message 3620 based upon the estimate sweep time Tm.
Program step 3512 supports estimating the distance T0 based upon the estimated sweep time Tm to generate the estimate distance T0 as shown in FIG. 41.

The duty cycle measured at the output of the comparators corresponds directly to the operating point of the RC curve. That means that adjusting the duty cycle higher, moves the operating range of the comparator to a lower (faster moving) part of the RC curve which in turn reduces the IF frequency of the RF mixer. It was found out experimentally that operating at a 70% duty cycle corresponds to approximately a 6.5 KHz IF frequency. The first step in the calibration process then is to adjust the DACs to measure a 70% duty cycle on the output.

There are two independent effects of temperature on the radar IF signal. First, the threshold offsets of the comparators vary with temperature causing a time shift, second the noise of the IF signal increases with increased temperature.

The time shift variation is eliminated by occasionally performing calibration radar sweeps, which sample the leading edge of the big bang using the DAC setting measured during calibration. A feedback loop is implemented in firmware to adjust the DAC such that the leading edge of the big bang is fixed to the same value it had during calibration. The DAC offset from its calibrated value is then filtered (to smooth operation) and applied to the DAC value used during normal radar operation.

Eliminating the noise in the IF signal is impossible, so the influence of the extra noise may be used during detection to adjust detection threshold. While noise increases with increased temperature, the radar return signal does not. Thus adjusting thresholds to temperature will improve sensitivity at low temperatures, which might not be the desired effect. Also, as temperatures lower the radar might uncover return signals that do not scale with temperature. How to handle this is still TBD. Right now we are looking for a method to measure the background noise so that its effects can be corrected. One method is to apply measure temperature and apply a log scale factor (i.e. linear if noise is measured in dB). Other methods are being examined.

In order to reduce the power consumption of the microradar 3100, we only need to listen to the radar signal after the initial Rx/Tx overlapping period, called the big bang. Adjusting the input voltage offset to U4 will advance (or delay) the timing pulses relative to U3. Thus we adjust the U4 DAC to start the radar sweep after the big bang. Experimentally it was determined that there is a near linear relationship between the offset time DAC setting and that the leading edge of the big bang. We use the leading edge of the big bang because it is not influenced by the radar return pulses. Thus, we measure the leading location of the big bang at two different duty cycles then we can compute a DAC value that will set the big bang before the start of the sweep.

The result of the calibration is an initial setting for the Rx and Tx DACs and a second setting of the Rx DAC that corresponds to setting the leading edge of the big bang at a fixed time location (currently 64 samples). This last value is used by the temperature compensation algorithm.

The input to the detection algorithm is 512 samples @ 40 us per sample for a total time of 20.48 ms.

In order to improve the signal to noise ratio (SNR) for detection, the IF signal is divided into time segments, each 32 samples long. It was found that better results could be obtained if the segments overlap by 16 samples. Therefore one complete scan is split into 31 bins or 32 samples each. The energy of the IF signal in each bin is then computed. This is computed by first subtracting the average (DC) component of signal and then computing the sum of the squares of the samples. A single average is computed for all bins, based on that part of the sweep that is past the influence of the big bang. Mode C shows the value of each bin in dB. For detection, a separate baseline is computed for each bin. A threshold is then computed based on this baseline.

For motion detection only 32 non-overlapping 32 sample bins are used. Motion is detected by subtracting the raw samples of one radar sweep from a previous sweep. This method has a couple of nice features: the average value of the difference is zero so that average need not be computed or subtracted before energy is computed, and the big bang signal present in the data is also subtracted so that the sensitivity is constant across the sweep. For motion detection a single threshold can be used for all bins.

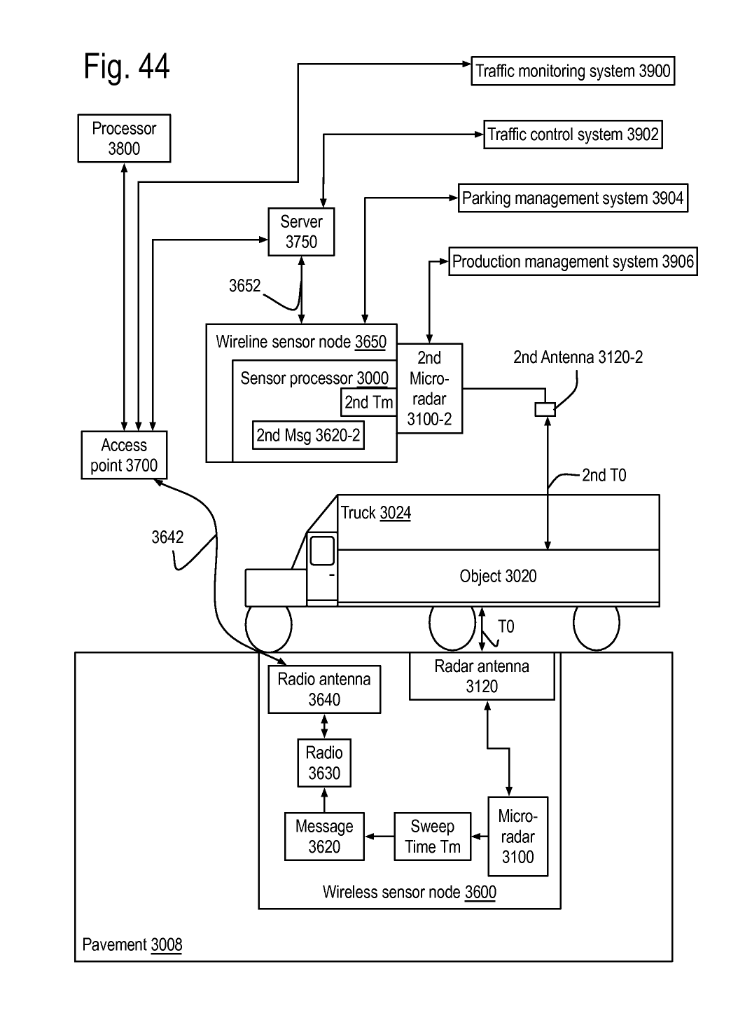

FIG. 44 shows a simplified network diagram of various systems that may include one or more communicative couplings 3642 and/or 3652 to the micro-radar 3100 and/or 3100-2 and/or the wireless sensor node 3600 and/or the wireline sensor node 3650 and/or the processor 3800 and/or the access point 3700 and/or the server 3750. The various systems include but are not limited to a traffic monitoring system 3900, a traffic control system 3902, a parking management system 3904 and/or a production management system 3906. Note that the second micro-radar 3100-2 may be used to estimate the distance T0 to the object 3020, which may be the surface of a filling 3028 in a chamber of the truck 3024, to determine how full it is of grapes or oranges, for example.

The preceding discussion serves to provide examples of the embodiments and is not meant to constrain the scope of the following claims.

1. A device, comprising at least one of:
a micro-radar is adapted to generate an antenna output of less than or equal to 10 milli-Watt (mW) through an antenna to an object and receive a Radio Frequency (RF) reflection off of said object, and adapted to respond to a first Digital to Analog Converter (DAC) output and a second DAC output;
a wireless sensor node and/or a processor for use in said wireless sensor node, comprising at least one of the configurations of:
configured for use in a first wireless sensor node and configured to receive a sensor reading N1 times per time unit generated by a sensor and to generate an improved sensor report including at least one improved estimate and/or an improved time stamp emulating said sensor readings received at least twice said N1 times per time unit, wherein said N1 is at least two;
configured to respond to at least one vibration reading of a vibration sensor responding to at least one vibration in pavement induced by a vehicle in movement on said pavement to generate at least one of a vibration report, a weight estimate of said vehicle, a deflection estimate of said pavement, a vehicle parameter of said vehicle including at least one of a length estimate, an axle count estimate, an axle spacing vector and/or an axle width estimate; and/or
configured to operate said micro-radar by control of said first DAC output and said second DAC output;
a wireline sensor node and/or a processor for use in said wireline sensor node configured operate said micro-radar by control of said first DAC output and said second DAC output;
a second apparatus configured to receive said improved sensor report from at least two of said first wireless sensor nodes to create at least one improved reading characteristic, where said improved reading characteristic includes at least one of an edge estimate, an extrema estimate, and/or a frequency domain estimate; and/or
a second processor for use with said second apparatus and configured to generate at least one of said vehicle parameter of said vehicle, a movement estimate of said vehicle passing between said wireless sensor nodes, and a traffic ticket message.

2. The device of claim 1, further comprising at least one of,
a third apparatus is adapted to respond to said vibrations in said pavement induced by said vehicle, comprising at least one of
a vibration sensor module including at least one vibration sensor configured to respond to said vibrations in said pavement to at least partly create at least one of said vibration reading;
a wireless vibration sensor including at least one vibration sensor configured to respond to said vibrations in said pavement to create at least one vibration reading and a radio transmitter configured to send a vibration report based upon said vibration reading;
said wireless vibration sensor node configured to be embedded in said pavement and including at least one vibration sensor configured to respond to said vibrations in said pavement to create at least one vibration reading and said radio; and
said embedded wireless vibration sensor node embedded in said pavement and including at least one vibration sensor configured to respond to said vibrations in said pavement to create at least one vibration reading and said radio transmitter; and
said micro-radar, comprising:
a timing generator adapted to generate a transmit signal with a first edge in response to said first DAC output and a sweep clock;
said timing generator adapted to generate a reception signal with a second edge in response to said second DAC and said sweep clock, where said second edge has a delay from said first edge that sweeps through a short delay to a long delay over a time interval;
said micro-radar generates a transmit RF burst in response to said first edge of said transmit signal for delivery to said antenna to generate said antenna output in response to said transmit pulse;
said micro-radar mixes a received RF reflection of said RF reflection and said transmit RF burst, in response to said second edge of said reception signal, to generate an Intermediate Frequency (IF) signal with a peak amplitude at a sweep delay Tm for a distance T0 of said object from said antenna; and
a frequency of said IF signal is one over a compression ratio of a carrier frequency of said antenna output, where said compression ratio is about one million.

3. The device of claim 1,
said micro-radar comprises at least one of:
a transmit control generator adapted to respond to said first DAC output and a first exponentially changing signal to generate a duty cycle of said transmit signal to stimulate a duty cycle estimator to generate said duty cycle signal; and/or
a reception control generator adapted to respond to said second DAC output, a second exponentially changing signal and a clock signal to generate said reception signal.

4. The device of claim 3, further comprising at least one of:
a first integrated circuit adapted to implement at least part of at least one of said micro-radar, said timing generator;
a second integrated circuit adapted to implement at least part of at least one of said wireless sensor node, said processor for use in said wireless sensor node, said wireline sensor node, and/or said processor for use in said wireline sensor node; and/or
a third integrated circuit adapted to implement at least part of at least one of said second apparatus and/or said second processor for use with said second apparatus.

5. The device of claim 1, further comprising
a system adapted to communicate with at least one of
said micro-radar,
said wireless sensor node,
said processor for use in said wireless sensor node, said wireline sensor node,
said processor for use in said wireline sensor node,
said second apparatus and/or
said second processor for use with said second apparatus.

6. The device of claim 5, wherein said system includes at least one of
a traffic speed enforcement system,
a traffic monitoring system,
a traffic management system,
a parking management system, and/or
a production management system.

7. The device of claim 2, wherein at least one of said processors and/or said second processor includes at least one instance of a finite state machine, a computer, and/or an accessible memory containing a program system configured to instruct said computer.

8. The device of claim 7, further comprising one of:
an installation device, a server and/or a computer readable memory,
each including said program system and/or an installation package configured
to instruct said computer to install said program system in said computer, said accessible memory and/or
configure said program system for implementation by said finite state machine.

9. The device of claim 7, wherein said program system includes and/or said finite state machine is configured to support at least part of at least one of the steps of:
generating said improved estimate with said improved time stamp emulating said sensor readings received at least twice said N1 times per time unit;
first-generating said vibration report in response to said vibration readings;
second-generating said vehicle parameter of said vehicle in response to said vibration readings and/or said vibration report;
third-generating said vehicle classification of said vehicle in response to said vehicle parameter;
fourth-generating said weight estimate and/or said deflection estimate in response to said vibration readings and/or said vibration report;
fifth-generating said vehicle travel record for said vehicle in response to said vehicle classification, said weight estimate, said deflection estimate, said vehicle identification and/or said vehicle movement estimate; and
sixth-generating said at least one of said traffic ticket message, said tariff message and/or said insurance message, each for said vehicle in response to said vehicle travel record;
and/or operating said micro-radar by control of said first DAC output and said second DAC output.

10. The device of claim 1, wherein said sensor includes at least one instance of at least one of a magnetic sensor, an electrostatic sensor, a humidity sensor, a proximity sensor, an accelerometer, a radar, said micro-radar, a strain sensor, an optical sensor and/or a temperature sensor.

11. The device of claim 1, wherein said object includes at least one of a person, a bicycle, a motorcycle, an automobile, a truck, a bus, a trailer, an aircraft, and/or the surface of a filling.
